(19) United States
(12) Patent Application Publication
(10) Pub. No.: US 2022/0000129 A1
(43) Pub. Date: Jan. 6, 2022

(54) SHELF STABLE POTATO PRODUCT

(71) Applicant: CORNELL UNIVERSITY, Ithaca, NY (US)

(72) Inventors: Syed S.H. RIZVI, Ithaca, NY (US); Vipul Prakash SARAN, Rochester, NY (US)

(73) Assignee: CORNELL UNIVERSITY, Ithaca, NY (US)

(21) Appl. No.: 17/282,755

(22) PCT Filed: Oct. 2, 2019
(86) PCT No.: PCT/US2019/054276

§ 371 Date: Apr. 3, 2021

Related U.S. Application Data
(60) Provisional application No. 62/740,892, filed on Oct. 3, 2018.

(51) Int. Cl. A23B 7/148; A23L 19/18; A23L 5/10; B65D 81/20; A23L 19/10

(52) U.S. Cl. CPC A23B 7/148; A23L 19/18; A23V 2002/00; B65D 81/2023; A23L 19/105; A23L 5/11

(57) ABSTRACT

A shelf stable potato/sweet potato french fry product packaged in a hermetically sealed flexible bag/pouch without the need for a surrounding acidic solution has been disclosed. Such product has a lower pH, preferably below 4.6, with enhanced taste and texture profile features, such as: (a) 0% -2% fat content, (b) a hardness of the exterior layer between 350 gram to 2500 gram after frying, that allows for little to no need for battering of such products, and (c) a moisture content above 55%. These benefits are typically obtained by processing the pre-cut potato via a single-step processing technique which may or may not require pre-processing steps.

### CROSS-REFERENCE TO RELATED APPLICATIONS

This application claims priority benefit of U.S. Provisional Patent Application Ser. No. 62/740,892, filed Oct. 3, 2018, the disclosure of which is hereby incorporated by reference herein in its entirety.

### BACKGROUND OF THE INVENTION

The composition of a typical raw potato is 80% moisture and 20% solids. A clean label potato french fry product which doesn't have any artificial and/or synthetic preservatives that is shelf stable with higher moisture content can have significant consumer benefits and also improve supply chain efficiencies. Currently the only solution in lieu for the fresh cut potato french fry is the frozen french fry. Frozen french fry has a huge market acceptability and has scaled tremendously in the last couple of decades. The reasons for the success of frozen french fry includes, factors such as (a) the convenience offered by the product to the restaurant operator. Such convenience of time required for preparation of the final product and the consistency of the final product through-out the year are very important to the end consumer in the food service industry, (b) the significantly longer shelf life due to the frozen storage. On the other hand, frozen french fry products utilize a lot of energy both during the processing and through-out the supply chain, post processing. Apart from the intensive energy consumption, the final end products (based on frozen french fries) can be high in calories and saturated fats derived from the various starch coatings which can be applied to the product or par frying the product in a fashion to get to an end product of desirable attributes such as better crispiness, better hold time after frying and better organoleptic properties. The product developed using the inventive process provides the same consumer benefits such as (a) similar time required for preparation of the product and consistency of the end product thought-out the year, (b) longer shelf life for the product in a non-refrigerated state while offering other consumer benefits such as lower calories from saturated fats since the requirement of starch coatings is minimal or nil to get to the same desirable attributes of better crispiness, better hold time after frying and better organoleptic properties. Apart from these advantageous factors, the processing technique of the inventive process has significantly less energy requirements and it also eliminates the requirements for the frozen or refrigerated supply chain post processing.

The present invention is directed to overcoming these and other deficiencies in the art.

### SUMMARY

The shelf stable potato french fry product has been developed using a novel processing technique. As used herein, “shelf stable” refers to a product that is storable in a non-refrigerated state (e.g., at a temperature above 60° F.) without compromising its safety for human consumption, and furthermore, without any requirement for freezing. For example, the United States Food and Drug Administration considers a product to be shelf stable when it is hermetically sealed and when stored at room temperature does not demonstrate microbial growth. Embodiments of the disclosed invention allows for the unique and advantageous factors such as lower pH, (preferably below 4.6) with enhanced taste and texture profile features such as: (a) about 30% lower oil uptake when fried in oil compared to a frozen potato product, (b) a harder exterior layer compared to a frozen potato product that allows for no or minimal need for battering of such products, (c) a lower fat to moisture ratio compared to products made using the known processes and (d) similar or less frying time and lower temperature as products made using known processes, to deliver an end product with better texture and taste profile compared to the frozen french fries. This processing technique utilizes high pressure carbon dioxide along with processing aid/s that achieve multiple benefits, including: (a) lowering of pH of the product, (b) infusion of the flavors to enhance the organoleptic properties of the product, and (c) relatively short cycle times by coming in direct contact with the product, packaged in a hermetically sealed bag to obtain the internal temperature to achieve commercial sterility thus resulting in minimum deterioration in texture qualities.

In one embodiment, the methodology of making the shelf stable potato product includes: (a) washing the potato followed by optional preheating, (b) peeling the potato {optional}, (c) cutting the potato as desired, (d) washing the potato to remove excess starch from the surface, (d) blanching the potato, (e) battering {optional}, (f) air drying/oven cooking/par frying {optional}, (g) packing the potatoes in hermetically sealed bags with breathable strips or valves on one side of the one end of the bag, (h) addition of one of more processing aids to the packaging, (i) sealing the bag, (j) placing the bag in the high pressure chamber, (k) pressurizing the chamber with pre heated carbon dioxide, (l) holding the bag at the required pressure and temperature parameters for a defined time (e.g., at which carbon dioxide is in a supercritical fluid state), (m) swift cycle depressurization of the chamber to facilitate a rapid change in the state of the carbon dioxide from supercritical phase to gas phase, (n) slow cycle depressurization of the chamber until the chamber is at atmospheric pressure, (o) sealing the processed bags underneath the breathable strip, and (p) cutting the breathable strip out.

In one embodiment, the methodology of making the shelf stable potato product includes: (a) washing the potato followed by optional preheating, (b) peeling the potato {optional}, (c) cutting the potato as desired, (d) washing the potato to remove excess starch from the surface, (d) blanching the potato, (e) battering {optional}, (f) air drying/oven cooking/par frying {optional}, (g) packing the potatoes in hermetically sealed bags with one side of the bag as a breathable side, (h) addition of one of more processing aids to the packaging, (i) sealing the bag, (j) placing the bag in the high pressure chamber, (k) pressurizing the chamber with pre heated carbon dioxide, (l) holding the bag at the required pressure and temperature parameters for a defined time (e.g., at which carbon dioxide is in a supercritical fluid state), (m) swift cycle depressurization of the chamber to facilitate a rapid change in the state of the carbon dioxide from supercritical phase to gas phase, (n) slow cycle depressurization of the chamber until the chamber is at atmospheric pressure, (o) placing the processed bag into another non breathable bag, and (p) sealing the non-breathable bag to form a multi layered packaging.

In another embodiment, the methodology of making the shelf stable potato product includes: (a) washing the potato followed by optional preheating, (b) peeling the potato {optional}, (c) cutting the potato as desired, (d) washing the potato to remove excess starch from the surface, (d) blanching the potato, (e) battering {optional}, (f) air drying/oven cooking/par frying {optional}, (g) packing the potatoes in hermetically sealed bags with breathable strips in the gusseted area at the bottom of the bag, (h) addition of one of more processing aids to the packaging, (i) sealing the bag, (j) placing the bag in the high pressure chamber, (k) pressurizing the chamber with pre heated carbon dioxide, (l) holding the bag at the required pressure and temperature parameters for a defined time (e.g., at which carbon dioxide is in a supercritical fluid state), (m) swift cycle depressurization of the chamber to facilitate a rapid change in the state of the carbon dioxide from supercritical phase to gas phase, (n) slow cycle depressurization of the chamber until the chamber is at atmospheric pressure, (o) sealing the processed bag by joining the ends of the polymer material to enclose the breathable strip within.

A first aspect of the present invention is embodied by a shelf stable product that includes a potato product disposed within packaging. The potato product is collectively defined by a plurality of individual potato segments. Each individual potato segment: 1) has a pH below about 4.6 throughout its entirety, where the pH throughout each individual potato segment varies by less than about 0.15; 2) has a moisture content within a range of about 65 wt % to about 85 wt %; and 3) has a fat content within a range of about 0 wt % to about 2 wt %.

A number of feature refinements and additional features are applicable to the first aspect of the present invention. These feature refinements and additional features may be used individually or in any combination. The following discussion is applicable to this first aspect, up to the start of the discussion of a second aspect of the present invention. Initially, the potato product may be in the form of a plurality of individual potato segments which may be the result of cutting raw potatoes of any appropriate type (and including sweet potatoes), such that the potato product could also be referred to as a cut potato product. The cut potato product may be in the form of a french fry product (e.g., each individual potato segment/french fry may have a width dimension within a range of about 3/16″ to about ½″ and a thickness dimension within a range of about 3/16″ to about ½″). Each individual potato segment/french fry may have one or more of the following characteristics: 1) a pH below about 4.5 throughout its entirety; 2) a moisture content within a range of about 70 wt % to about 85 wt %; and 3) a solids content within a range of about 15 wt % to about 30 wt %. The specified pH values for the cut potato product may be realized without having any acidic solution suspension within the packaging.

A partial vacuum may exist within the packaging. The packaging may be characterized as being in the form of a sealed bag, pouch, or the like. One or more sheets may be sealed together in any appropriate manner (e.g., heat sealing; RF sealing) to define the packaging, for instance to define an enclosed space within the packaging for receipt/storage of the potato product. One embodiment has each sheet of the packaging with a wall thickness of no more than about 0.0035″. Another characterization is that the packaging is flexible (e.g., capable of bending easily without breaking). The packaging may also be characterized as being pliable such that movement of the potato product within the packaging may change the contour of the packaging and without elastically deforming the packaging.

A first embodiment entails the packaging having first and second sections (or packaging sections), each of which defines at least part of a common internal storage space for receipt of the potato product. At least part of the first section has a first permeability that is greater than a second permeability of the second section at least under a first condition (e.g., under supercritical conditions for carbon dioxide). One embodiment has the first permeability of at least part of the first section being greater than a permeability of the entirety of the second section at least under the noted first condition. In any case, the first embodiment packaging may be characterized as being disposable in first and second configurations. The first configuration for this first embodiment entails the packaging having each of the noted first and second sections (including where the first and second sections are disposed in end-to-end relation; e.g., for processing of the cut potato product). The second configuration for this first embodiment entails the first section being removed such that the entirety of the cut potato product is within a remaining portion of the second section (and which itself may be in a sealed state; e.g., for storage of the cut potato product after processing).

A second embodiment entails the packaging including first packaging that is disposed and sealed within second packaging, with the potato product being contained within the first packaging. The first packaging may be referred to as “inner packaging” or “primary packaging,” while the second packaging may be referred to as “outer packaging” or “secondary packaging”. At least part of the first packaging has a permeability that is greater than a permeability of the entirety of the second packaging at least under a first condition (e.g., under supercritical conditions for carbon dioxide).

A third embodiment entails the packaging being disposable in each of first and second configurations. The first configuration for this third embodiment packaging entails a first section of the packaging being on an exterior of the packaging, and with the first section having a first permeability that is greater than a permeability of the remainder of the packaging at least under a first condition (e.g., under supercritical conditions for carbon dioxide). An end or bottom of the third embodiment packaging may be defined at least in part by this first section for its corresponding first configuration (e.g., for processing of the potato product while within the packaging). The second configuration for this third embodiment packaging entails the noted first section being enclosed or sealed within an interior of the packaging (e.g., for storage of the potato product after processing). This second configuration for this third embodiment packaging may be realized by directing the first section (with the third embodiment packaging then being in its corresponding first configuration) toward an interior of the packaging, and then sealing the first section within this interior to define this second configuration for the third embodiment packaging.

A fourth embodiment entails the packaging having first and second internal spaces, with a partition being between the first and second internal spaces, and with the cut potato product being in the first internal space. The partition has a first permeability that is greater than a permeability of the remainder of the packaging at least under a first condition (e.g., under supercritical conditions for carbon dioxide). This fourth embodiment may be characterized as the above-noted second configuration for the third embodiment of the packaging.

A second aspect of the present invention is embodied by a method of providing a product. A potato product and one or more processing aids are disposed in packaging, and thereafter the packaging is sealed (e.g., to enclose both the potato product and processing aid(s) within the packaging). The potato product is subjected to a supercritical carbon dioxide process within a chamber and while remaining sealed within the packaging (along with the processing aid(s)). After the supercritical carbon dioxide processing, the chamber is depressurized in multiple, distinct stages—at least a first depressurization and a second depressurization stage. The first depressurization stage uses a first depressurization rate and the second depressurization stage uses a second depressurization rate, with the second depressurization rate being less than the first depressurization rate and with the second depressurization stage occurring after the first depressurization stage.

A number of feature refinements and additional features are applicable to this second aspect of the present invention. These feature refinements and additional features may be used individually or in any combination. The following discussion is applicable to this second aspect. Initially, the potato product may be in the form of a plurality of individual potato segments such as french fries. These individual potato segments may be the result of cutting raw potatoes, such that the potato product could also be referred to as a cut potato product. In any case and after the supercritical carbon dioxide processing, the potato product may have the characteristics discussed above in relation to the first aspect.

The supercritical carbon dioxide processing in accordance with the second aspect may entail precluding flow out of the chamber throughout the supercritical carbon dioxide processing. Infusion of one or more processing aids into the potato product may be realized by the supercritical carbon dioxide processing, and the first depressurization stage may thereafter retain one or more of the infused processing aids within the potato product to yield a pH of below 4.6 throughout the potato product (and including where the pH varies less than about 0.15 throughout the potato product). The supercritical carbon dioxide processing may be conducted such that the resulting moisture content of the potato product may be within a range of about 65 wt % to about 85 wt % (after the supercritical carbon dioxide processing and the subsequent multi-stage depressurization).

The first depressurization stage may reduce the pressure in the chamber from a supercritical pressure to a pressure below the critical point of carbon dioxide (e.g., from an operating pressure to a lower, first pressure). Stated another way, the first depressurization stage provides for a change (e.g., rapid) in state of the carbon dioxide from a supercritical phase to a gas phase. The second depressurization stage may reduce the pressure in the chamber from the noted first pressure to a lower, second pressure, such as about atmospheric pressure. One embodiment has the second depressurization rate being no more than 25% of the first depressurization rate. Another embodiment has the second depressurization rate being no more than 10% of the first depressurization rate. Yet another embodiment has the second depressurization rate being no more than 5% of the first depressurization rate. The minimum depressurization rate to reduce the chamber pressure from supercritical pressure to the noted first pressure may be significantly greater than a maximum depressurization rate that is used to reduce the chamber pressure from the noted first pressure to the noted second pressure (including where the maximum second depressurization rate is no more than 25% of the minimum first depressurization rate). Other relative depressurization rates may be appropriate for the first and second depressurization stages.

The potato product may remain sealed in the packaging throughout the supercritical carbon dioxide processing, and may thereafter may remain sealed in at least part of this same packaging throughout the remainder of its life cycle (e.g., throughout storage and until cooking/consumption), and including without having to refrigerate the same and with the potato product remaining in a shelf stable condition. In one embodiment, the packaging is cooled from a first temperature to a second temperature to create a partial vacuum within the packaging. The first temperature may be close to the temperature experienced by the potato product during the supercritical carbon dioxide processing, and the second temperature may be close to ambient temperature. This cooling may take place after the supercritical carbon dioxide processing and furthermore after the multi-stage depressurization (for instance, after the packaging has been removed from the chamber).

A number of different packaging configurations may be used in relation to this second aspect, and each of which may be used in conjunction with the first aspect (and vice versa). A first embodiment entails the packaging having first and second sections (or first and second packaging sections), each of which defines at least part of a common internal storage space for receipt of the potato product. At least part of the first section has a first permeability that is greater than a second permeability of the second section at least under a first condition (e.g., under supercritical conditions for carbon dioxide). One embodiment has the first permeability of at least part of the first section being greater than a permeability of the entirety of the second section at least under the noted first condition. In any case, the first embodiment packaging with the noted first and second sections is used for the supercritical carbon dioxide processing of the potato product within the chamber, and with the supercritical carbon dioxide entering the packaging through the first section. After the chamber has been depressurized, the packaging is removed from the chamber, and thereafter the packaging is sealed such that the first section of the first embodiment packaging can be removed and such that the cut potato product remains sealed within the remainder of the packaging (and that includes at least part of the noted second section, but none of the first section). The entirety of the packaging, after removal of the first section, may be non-breathable or formed from a non-breathable material.

A second embodiment entails disposing and sealing the packaging within second packaging after the supercritical carbon dioxide processing and furthermore after the multi-stage depressurization (for instance, after the packaging has been removed from the chamber). At least part (e.g., a first part) of the packaging (which was subjected to the supercritical carbon dioxide processing within the chamber) has a permeability that is greater than a permeability of the entirety of the second packaging at least under a first condition (e.g., under supercritical conditions for carbon dioxide). As such, supercritical carbon dioxide enters the packaging through this first part of the packaging during supercritical carbon dioxide processing within the chamber. The entirety of the second packaging may be non-breathable or formed from a non-breathable material.

A third embodiment entails the packaging including a first section with a first permeability that is greater than a permeability of the remainder of the packaging at least under a first condition (e.g., under supercritical conditions for carbon dioxide). The packaging is in a first configuration when exposed to the supercritical carbon dioxide processing within the chamber, and with the noted first section being on an exterior of the packaging in this first configuration (e.g., an end or bottom of the third embodiment packaging may be defined at least in part by this first section for the noted first configuration). Supercritical carbon dioxide may enter the packaging through this first section of the packaging during supercritical carbon dioxide processing within the chamber, and again while the third embodiment packaging is in its corresponding first configuration. After the supercritical carbon dioxide processing, and furthermore after the multi-stage depressurization (for instance, after the packaging has been removed from the chamber), the third embodiment packaging may be disposed in a second configuration where the noted first section is now enclosed with an interior of the third embodiment packaging. This second configuration for this third embodiment packaging may be realized by directing the first section toward an interior of the packaging, and then sealing the first section within this interior to define the second configuration for the third embodiment packaging. The entirety of the exterior of the third embodiment packaging in its corresponding second configuration may be non-breathable or formed from a non-breathable material.

Various aspects of the present invention are also addressed by the following Paragraphs 1-67 and in the noted combinations thereof, as follows:

Paragraph 1: A product comprising: a flexible packaging, and a cut potato product disposed within the flexible packaging, the potato product comprising: a pH below about 4.6 throughout the cut potato product, wherein the pH varies less than about 0.15 throughout the cut potato product; a moisture content of about 65 wt % to about 85 wt %; and a fat content of about 0 wt % to about 2 wt %.

Paragraph 2: The product of Paragraph 1, the cut potato product having a width dimension of about 3/16 inch to about ½ inch and a thickness dimension of about 3/16 inch to about ½ inch.

Paragraph 3: The product of any of the preceding Paragraphs 1-2, wherein the cut potato product has a moisture content of about 70 wt % to about 85 wt %.

Paragraph 4: The product of any of the preceding Paragraphs 1-3, wherein the cut potato product has a solids content of about 15 wt % to about 30 wt %.

Paragraph 5: The product of any of the preceding Paragraphs 1-4, wherein the cut potato product has a pH below 4.5 throughout the cut potato product.

Paragraph 6: The product of any of the preceding Paragraphs 1-5, wherein the flexible packaging lacks an acidic solution suspension.

Paragraph 7: The product of any of the preceding Paragraphs 1-6, the cut potato product forming a cooked potato product after being fried in canola oil for about 3-4 minutes at about 350° F., the cooked potato product having a moisture content of about 45 wt % to about 55 wt %, and a fat content of about 6 wt % to about 12 wt %.

Paragraph 8: The product of any of the preceding Paragraphs 1-7, the cut potato product forming a cooked potato product after being fried in canola oil for about 3-4 minutes at about 350° F., the cooked potato product having a surface hardness measure of about 350 grams to about 2500 grams when measured by a puncture test using a 3mm probe at a test speed of 2mm/sec within 120 seconds of completing frying.

Paragraph 9: The product of any of Paragraphs 1-6, the cut potato product forming a cooked potato product after being fried in canola oil for about 3-4 minutes at about 350° F., the cooked potato product having a moisture content of about 53 wt % to about 65 wt %.

Paragraph 10: The product of any of the preceding Paragraphs 1-9, the cut potato product forming a cooked potato product after being fried in canola oil for about 3-4 minutes at about 350° F., the cooked potato product having a solids content of about 28 wt % to about 40 wt %.

Paragraph 11: The product of any of the preceding Paragraphs 1-10, the cut potato product forming a cooked potato product after being fried in canola oil for about 3-4 minutes at about 350° F., the cooked potato product having a fat content of about 6 wt % to about 10 wt %.

Paragraph 12: The product of any of Paragraphs 1-7, the cut potato product having a width of about ⅜ inch and a thickness of about ⅜ inch, the cut potato product forming a cooked potato product after being fried in canola oil for about 3-4 minutes at about 350° F., the cooked potato product having a surface hardness measure of about 300 grams to about 500 grams when measured by a puncture test using a 3mm probe at a test speed of 2mm/sec within about 120 seconds of completing frying.

Paragraph 13: The product of any of Paragraphs 1-7, the cut potato product having a width of about 3/16 inch and a thickness of about 3/16 inch, the cut potato product forming a cooked potato product after being fried in canola oil for about 90 seconds at about 350° F., the cooked potato product having a surface hardness measure of about 2000 grams to about 4000 grams when measured by a puncture test using a 3mm probe at a test speed of 2mm/sec within about 120 seconds of completing frying.

Paragraph 14: The product of any of the preceding Paragraphs 1-13, wherein an interior volume of the flexible packaging is at a partial vacuum pressure.

Paragraph 15: The product of any of Paragraphs 1-13, wherein the flexible packaging comprises a first section having a first permeability that is greater than a permeability of a remainder of the flexible packaging, and wherein an internal volume of the remainder of the flexible packaging accommodates receipt of an entirety of the cut potato product.

Paragraph 16: The product of Paragraph 15, wherein an interior volume of the remainder of the flexible packaging is at a partial vacuum pressure.

Paragraph 17: The product of any of Paragraphs 1-13, further comprising a second flexible packaging, wherein the flexible packaging is sealed within the second flexible packaging, and wherein at least part of the flexible packaging has a permeability that is greater than a permeability of the second flexible packaging.

Paragraph 18: The product of Paragraph 17, wherein an interior volume of the second flexible packaging is at a partial vacuum pressure.

Paragraph 19: The product of any of Paragraphs 1-13, wherein the flexible packaging is disposable in first and second configurations, the first configuration comprising a first section of the flexible packaging being on an exterior of the flexible packaging, the first section having a first permeability that is greater than a permeability of a remainder of the flexible packaging, and the second configuration comprising the first section being enclosed within an interior of the flexible packaging.

Paragraph 20: The product of Paragraph 19, wherein the first section comprises a gusset of the flexible packaging.

Paragraph 21: The product of any of Paragraphs 19-20, wherein an interior volume of the flexible packaging is at a partial vacuum pressure.

Paragraph 22: The product of any of Paragraphs 1-13, wherein the flexible packaging comprises first and second internal spaces, with a first partition between the first and second internal spaces, the first partition having a first permeability that is greater than a permeability of a remainder of the flexible packaging, and wherein the cut potato product is in the first internal space.

Paragraph 23: The product of Paragraph 22, wherein the first internal space of the flexible packaging is at a partial vacuum pressure.

Paragraph 24: The product of any of the preceding Paragraphs 1-23, the cut potato product further comprising a batter.

Paragraph 25: The product of Paragraph 24, wherein the batter comprises one or more of a native starch, a modified starch, salt, sugar, glucose, dextrose, a flavoring agent, or a spice.

Paragraph 26: The product of any of the preceding Paragraphs 1-25, wherein the cut potato product is substantially free from artificial preservatives.

Paragraph 27: A method of making a product, comprising: cutting a potato to form a cut potato product; blanching the cut potato product; disposing the cut potato product in a package having at least a portion that permits passage of carbon dioxide; adding one or more one processing aids to the package; treating the cut potato product in a chamber with a supercritical carbon dioxide process at a first pressure and a first temperature under conditions to prevent outflow of supercritical carbon dioxide from the chamber during the process to infuse the one or more processing aids into the cut potato product; depressurizing the treated cut potato product at a first depressurization rate of about 80 psi/sec to about 300 psi/sec to a second pressure to trap the one or more processing aids within the cut potato product; depressurizing the cut potato product at a second depressurization rate of less than about 40 psi/sec from the second pressure to about atmospheric pressure; and sealing the portion of the package that permits passage of carbon dioxide.

Paragraph 28: The method of Paragraph 27, further comprising reducing a moisture content of the cut potato product after blanching the cut potato product and before disposing the cut potato product in the package using one or more of frying, baking, microwave heating, or air drying.

Paragraph 29: The method of Paragraph 28, wherein the reducing the moisture content of the cut potato product is conducted at about 100° F. to about 450° F. for about 15 seconds to about 30 minutes.

Paragraph 30: The method of any of Paragraphs 27-29, the cutting the potato to form the cut potato product including cutting the potato into pieces of about 3/16 inch to about ½ inch thick and about 3/16 inch to about ½ inch width.

Paragraph 31: The method of any of Paragraphs 27-30, the adding the one or more processing aid including adding about 5 wt % of the one or more processing aids relative to the cut potato product.

Paragraph 32: The method of any of Paragraphs 27-31, wherein the sealing the portion of the package that permits passage of carbon dioxide includes melting portions of the package together.

Paragraph 33: The method of any of Paragraphs 27-31, wherein the sealing the portion of the package that permits passage of carbon dioxide includes disposing the package in a secondary package and sealing the secondary package.

Paragraph 34: The method of any of Paragraphs 27-33, the blanching the cut potato product including blanching the cut potato product in a solution including one or more of citric acid, gluconodeltalactone, sodium acid pyrophosphate, or sodium bisulfate.

Paragraph 35: The method of any of Paragraphs 27-34, the blanching the cut potato product including blanching the cut potato for about 30 seconds to about 60 minutes at a temperature of about 122° F. to about 248° F.

Paragraph 36: The method of any of Paragraphs 27-35, further comprising coating at least a portion of the cut potato product with a batter after blanching the cut potato product.

Paragraph 37: The method of Paragraph 36, wherein the batter comprises one or more of a native starch, a modified starch, salt, sugar, glucose, dextrose, a flavoring agent, or a spice.

Paragraph 38: The method of any of Paragraphs 27-37, wherein the one or more processing aids includes one or more of nisin, distilled water vinegar, vinegar, lemon juice, lemon juice concentrate, apple juice, apple juice concentrate, cumin seed, ginger, garlic, lactic acid, gluconic acid, malic acid, peroxyacetic acid, tartaric acid, acetic acid, acetic acid derivatives, sodium bisulfate, gluconodeltalactone (GDL), citric acid, buffer of lactic acid, buffer of gluconic acid, buffer of malic acid, buffer of peroxyacetic acid, buffer of tartaric acid, buffer of acetic acid, buffer of acetic acid derivatives, buffer of citric acid, oleoresins, vegetable oil, canola oil, truffle oil, onion extract, clove, clove extracts, paprika extracts, cumin, cumin extracts, deionized water, and distilled water.

Paragraph 39: The method of any of Paragraphs 27-38, wherein the first pressure is about 1071 psi to about 7000 psi.

Paragraph 40: The method of any of Paragraphs 27-39, wherein the first temperature is about 88° F. to about 250° F.

Paragraph 41: The method of any of Paragraphs 27-40, wherein the supercritical carbon dioxide process is conducted for about 30 seconds to about 60 minutes.

Paragraph 42: The method of any of Paragraphs 27-41, wherein the supercritical carbon dioxide process is conducted for about 30 seconds to about 30 minutes.

Paragraph 43: The method of any of Paragraphs 27-42, wherein the supercritical carbon dioxide process is conducted for about 8 minutes to about 12 minutes.

Paragraph 44: The method of any of Paragraphs 27-43, further comprising forming a partial vacuum in the package via cooling the package after sealing the portion of the package that permits passage of carbon dioxide.

Paragraph 45: A method of making a product, comprising: cutting a potato to form a cut potato product; blanching the cut potato product; disposing the cut potato product in a package having at least a portion that permits passage of carbon dioxide; adding one or more one processing aids to the package; treating the cut potato product in a chamber with a supercritical carbon dioxide process at a first pressure and a first temperature under conditions to prevent outflow of supercritical carbon dioxide from the chamber during the process to infuse the one or more processing aids into the cut potato product; depressurizing the treated cut potato product from the first pressure to a second pressure below the supercritical carbon dioxide critical pressure within about 1 second to about 60 seconds to trap the one or more processing aids within the cut potato product; depressurizing the cut potato product from the second pressure to about atmospheric pressure at a depressurization rate of less than about 40 psi/sec; and sealing the portion of the package that permits passage of carbon dioxide.

Paragraph 46: The method of Paragraph 45, further comprising reducing a moisture content of the cut potato product after blanching the cut potato product and before disposing the cut potato product in the package using one or more of frying, baking, microwave heating, or air drying.

Paragraph 47: The method of any of Paragraphs 45-46, wherein the reducing of the moisture content of the cut potato product is conducted at about 100° F. to about 450° F. for about 15 seconds to about 30 minutes.

Paragraph 48: The method of any of Paragraphs 45-47, the cutting the potato to form the cut potato product including cutting the potato into pieces of about 3/16 inch to about ½ inch thick and about 3/16 inch to about ½ inch width.

Paragraph 49: The method of any of Paragraphs 45-48, the adding the one or more processing aid including adding about 5 wt % of the one or more processing aids relative to the cut potato product.

Paragraph 50: The method of any of Paragraphs 45-49, wherein the sealing the portion of the package that permits passage of carbon dioxide includes melting portions of the package together.

Paragraph 51: The method of any of Paragraphs 45-49, wherein the sealing the portion of the package that permits passage of carbon dioxide includes disposing the package in a secondary package and sealing the secondary package.

Paragraph 52: The method of any of Paragraphs 45-51, the blanching the cut potato product including blanching the cut potato product in a solution including one or more of citric acid, gluconodeltalactone, sodium acid pyrophosphate, or sodium bisulfate.

Paragraph 53: The method of any of Paragraphs 45-52, the blanching the cut potato product including blanching the cut potato for about 30 seconds to about 60 minutes at a temperature of about 122° F. to about 248° F.

Paragraph 54: The method of any of Paragraphs 45-53, wherein the one or more processing aids includes one or more of nisin, distilled water vinegar, vinegar, lemon juice, lemon juice concentrate, apple juice, apple juice concentrate, cumin seed, ginger, garlic, lactic acid, gluconic acid, malic acid, peroxyacetic acid, tartaric acid, acetic acid, acetic acid derivatives, sodium bisulfate, gluconodeltalactone (GDL), citric acid, buffer of lactic acid, buffer of gluconic acid, buffer of malic acid, buffer of peroxyacetic acid, buffer of tartaric acid, buffer of acetic acid, buffer of acetic acid derivatives, buffer of citric acid, oleoresins, vegetable oil, canola oil, truffle oil, onion extract, clove, clove extracts, paprika extracts, cumin, cumin extracts, deionized water, and distilled water.

Paragraph 55: The method of any of Paragraphs 45-54, wherein the first pressure is above 1071 psi to about 7000 psi.

Paragraph 56: The method of any of Paragraphs 45-55, wherein the first temperature is about 88° F. to about 250° F.

Paragraph 57: The method of any of Paragraphs 45-56, wherein the supercritical carbon dioxide process is conducted for about 30 seconds to about 60 minutes.

Paragraph 58: The method of any of Paragraphs 45-57, wherein the supercritical carbon dioxide process is conducted for about 30 seconds to about 30 minutes.

Paragraph 59: The method of any of Paragraphs 45-58, wherein the supercritical carbon dioxide process is conducted for about 8 minutes to about 12 minutes.

Paragraph 60: The method of any of Paragraphs 45-59, further comprising coating at least a portion of the cut potato product with a batter after blanching the cut potato product.

Paragraph 61: The method of Paragraph 60, wherein the batter comprises one or more of a native starch, a modified starch, salt, sugar, glucose, dextrose, a flavoring agent, or a spice.

Paragraph 62: The method of any of Paragraphs 45-61, wherein the depressurizing the treated cut potato product from the first pressure to the second pressure occurs within about 1 second to about 50 seconds.

Paragraph 63: The method of any of Paragraphs 45-62, wherein the depressurizing the treated cut potato product from the first pressure to the second pressure occurs within about 1 second to about 40 seconds.

Paragraph 64: The method of any of Paragraphs 45-63, wherein the depressurizing the treated cut potato product from the first pressure to the second pressure occurs within about 1 second to about 30 seconds.

Paragraph 65: The method of any of Paragraphs 45-64, wherein the depressurizing the treated cut potato product from the first pressure to the second pressure occurs within about 1 second to about 20 seconds.

Paragraph 66: The method of any of Paragraphs 45-65, wherein the depressurizing the treated cut potato product from the first pressure to the second pressure occurs within about 1 second to about 10 seconds.

Paragraph 67: The method of any of Paragraphs 45-66, further comprising forming a partial vacuum in the package via cooling the package after sealing the portion of the package that permits passage of carbon dioxide.

These and other objects, features, and advantages of this invention will become apparent from the following detailed description of the various aspects of the invention taken in conjunction with the accompanying drawings.

### DESCRIPTION OF THE DRAWINGS

FIG. 1 shows an illustrative process for producing a shelf stable potato french fry product.

FIG. 2 is a sketch of the packaging of one embodiment immediately after processing a potato french fry product.

FIG. 3 is a sketch of the packaging after sealing and cutting of a breathable strip of the packaging of FIG. 2.

FIGS. 4A₁-4A₄ are sketches of a first embodiment of product packaging of the present disclosure. FIG. 4A₁ illustrates a front view of the first embodiment. FIG. 4A₂ illustrates a perspective view of an open end of the first embodiment to accommodate loading product in the packaging for processing. FIG. 4A₃ illustrates a front view of a first or processing configuration for the first embodiment, with a representative number of French fries being shown in the packaging for processing. FIG. 4A₄ illustrates a front view of a second or post-processing storage configuration of the first embodiment, with a representative number of French fries being shown in the packaging.

FIGS. 4B₁-4B₄ are sketches of an inner packaging for a second embodiment of product packaging of the present disclosure. FIG. 4B₁ illustrates a front view of the inner packaging of the second embodiment, prior to loading product into the inner packaging. FIG. 4B₂ illustrates a rear view of the inner packaging of the second embodiment, prior to loading product into the inner packaging. FIG. 4B₃ illustrates a perspective view of the inner packaging of the second embodiment, with product contained in the inner packaging. FIG. 4B₄ illustrates a cross-sectional view of the inner packaging of the second embodiment, with a representative number of French fries being shown in the inner packaging.

FIGS. 4C₁-4C₄ are sketches of a third embodiment of product packaging of the present disclosure. FIG. 4C₁ illustrates a pre-processing side view of the third embodiment. FIG. 4C₂ illustrates a front view of the third embodiment. FIG. 4C₃ illustrates a bottom view of the third embodiment and prior to disposing the same in a storage configuration. FIG. 4C₄ illustrates a post-processing perspective view of the third embodiment.

FIG. 5 illustrates an embodiment of a system for conducting a supercritical carbon dioxide process.

FIG. 6A illustrates a comparison of textural properties of products produced by embodiments of a supercritical carbon dioxide process and commercially available frozen products.

FIG. 6B illustrates a comparison of textural properties of products produced by embodiments of a supercritical carbon dioxide process and commercially available frozen products.

FIG. 6C illustrates a comparison of textural properties of products produced by embodiments of a supercritical carbon dioxide process and commercially available frozen products.

FIG. 7 illustrates a comparison of textural properties of products produced by embodiments of a supercritical carbon dioxide process and commercially available frozen products.

FIG. 8A illustrates a comparison of moisture and fat content after frying of products produced by embodiments of a supercritical carbon dioxide process and commercially available frozen products.

FIG. 8B illustrates a comparison of moisture and fat content after frying of products produced by embodiments of a supercritical carbon dioxide process and commercially available frozen products.

FIG. 9 illustrates the pH of products produced by embodiments of a supercritical carbon dioxide process recorded for different process time periods.

FIG. 10A illustrates internal temperature readings at different time intervals for the duration of an embodiment of a supercritical carbon dioxide process.

FIG. 10B illustrates internal temperature readings at different time intervals for the duration of an embodiment of a supercritical carbon dioxide process.

FIG. 10C illustrates internal temperature readings at different time intervals for the duration of an embodiment of a supercritical carbon dioxide process.

FIG. 10D illustrates internal temperature readings at different time intervals for the duration of an embodiment of a supercritical carbon dioxide process.

FIG. 11 illustrates microbial shelf life study data for APC bacteria growth over a storage duration of 60 days at room temperature for a product produced by an embodiment of a supercritical carbon dioxide process.

FIG. 12 illustrates microbial shelf life study data for mold growth over a storage duration of 60 days at room temperature for a product produced by an embodiment of a supercritical carbon dioxide process.

FIGS. 13A-13C are sketches of the second embodiment of product packaging after sealing the inner packaging (FIGS. 4B₁-4B₄) within outer packaging according to an embodiment of the present disclosure. FIG. 13A illustrates a front view of the second embodiment of the product packaging and that illustrates product contained within the inner packaging and with the inner packaging being enclosed within the outer packaging. FIG. 13B illustrates a rear view of the second embodiment of the product packaging, with the inner packaging being enclosed within the outer packaging. FIG. 13C illustrates a cross-sectional view of the second embodiment of product packaging, with a representative number of French fries being shown within the inner packaging while enclosed within the outer packaging.

### DETAILED DESCRIPTION

A shelf stable potato french fry product free from artificial preservatives provides the food service industry with an alternative to frozen french fries. Currently, no suitable alternative is widely available, which puts significant strains on the industry in terms of energy usage for cold storage and also in restrictions in markets where cold storage infrastructure is unavailable. The foodservice industry is a large consumer of processed potato products, which include items such as potato french fries, breakfast hash brown potato, tater tots, mashed potatoes and other such types of products derived from either potatoes or such root vegetables. Products described herein not only have the ability to eliminate the frozen and refrigerated storage space but have the ability to still provide the same or better convenience to the consumer such as: (a) similar or better cooking time at same or lower temperatures compared to conventional frozen products, and (b) zero preparation of the product before frying. With no cold chain systems, these products also offer great cost savings to the distributors and reduce the carbon footprint in the environment.

Prior processes that seek to create control points for shelf stability have generally been utilized to create a chip product consumed for snacking which are fried to lower the water activity of the end product below 0.6 to inhibit the growth of any micro-organism. Such prior processes have also been utilized to create products which require cooking prior to consumption. Such products also have water activity as a control point to inhibit the growth of micro-organisms but could have higher moisture content to replicate the texture and taste profile of an end product derived from cooking a raw potato. These products would have various types of humectants such as sugar and salt combinations; vegetable glycerin; propylene glycol and products like such in their recipes to control for a lower water activity while having a higher moisture content.

Embodiments described herein avoid the need to create a mashed product which are liquid or semi-solid/slurry products, in which acidulants are added and then heat is applied to the bag after packaging. Embodiments described herein also avoid the need to package potatoes in a rigid can and add an acidic solution to top off the can, thereby providing an acidic solution suspension. Such products are created by sealing the can and thermally treating the can to achieve commercial sterility by achieving the required internal temperature throughout the entire potato due to the heat applied on the outside of the can during the process. The heat applied to the outside of the can is conducted from the periphery of the can gradually to the inside until the entire potato, including the cross-sectional center of the potato, has reached the required internal temperature. Such end products are best classified as canned potatoes within an acidic solution.

Aspects of this disclosure pertain to a shelf stable potato product in a unique flexible package/packaging without the need of an acidic solution suspension present inside the bag and a process that utilizes this unique style of packaging to achieve the various advantageous end product attributes including: equilibrium pH below 4.6, shelf stability, color profile, fat to moisture ratio, texture profile, cooking profile, and flavor profile.

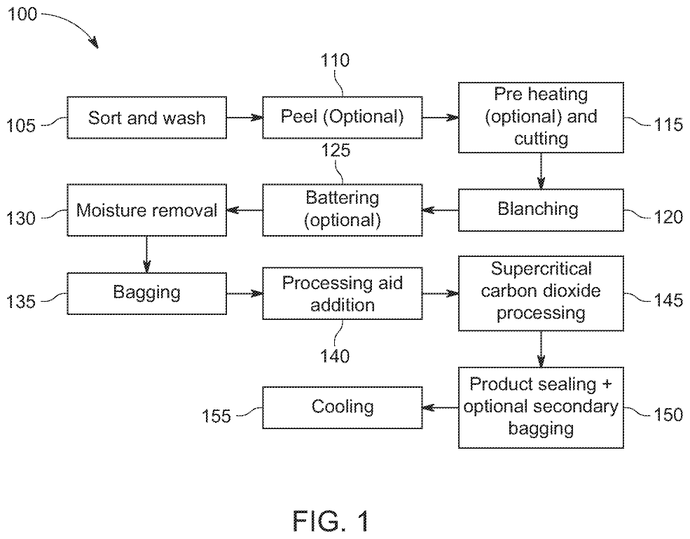

Referring to FIG. 1, embodiments of the present invention include a process 100 for preparing a shelf stable potato/sweet potato product.

According to process 100, tubers are first sorted and washed (step 105) and optionally peeled (step 110). If a finished product with peel remaining intact is desired, the peeling is omitted. The whole tubers are then optionally pre heated ranging between 1 minute to 60 minutes to get to an internal temperature of 120 to 170 degrees Fahrenheit (step 115). The tubers are then cut, either mechanically or using hydro-jet cutters or with other similar devices (step 115).

After cutting the tubers, they are blanched (step 120). The blanching step allows for the increase in the cell permeability. The step of blanching may include addition of certain ingredients such as chelating agents or other flavoring compounds. The chelating agents could include citric acid, sodium acid pyrophosphate, calcium chloride, sodium bisulfate and other ingredients like such. In some embodiments, the dosage is 0.1%, weight basis, and above of the water solution (unless otherwise specified, percentage values herein are expressed in weight basis (wt %)). The flavoring compounds could include various spice combinations and other extracts and oleoresins. The temperature of blanching could range from 50° C. to 120° C. for a time period between 30 seconds to 60 minutes. After exposing the cut tubers to the elevated temperature for the desired time period, the tubers are rapidly cooled (e.g., by immersion in chilled water or an ice bath.)

Following the blanching step is an optional battering step (step 125). Inclusion of battering is dependent on the desired attributes of end product. The battering step could include dry batters which could be a combination of either native starches consisting of corn starch, all-purpose flour, rice flour, tapioca starch, pea starch, potato starch and other like these or modified starches. The batter can be formed by mixing the desired quantities of the above mentioned ingredients and adding measured quantity of water to it to form a slurry that would allow for a batter pickup by the product between 0.01% to 20% weight basis. Apart from the starches, the batter mixture could also include some quantities of salt and sugar/dextrose or other flavoring agents and spice combinations. Each ingredient could range between 0.1% to 100% of total weight of the batter.

After battering, the product is set for an intermediate, optional processing step termed as “Moisture Removal” (step 130). This step generally includes a first portion of moisture removal via methods that include but are not limited to air dried/oven cooked/par fried in oil, which serves not only to remove moisture but also to set any optional batter that was added to the product. In case of air drying/oven cooking the processing time could vary between 15 seconds to 30 minutes at temperatures between 100° F. to 450° F. In case of par frying the processing time could vary between 15 seconds to 5 minutes at a temperature between 200° F. to 450° F.

After the moisture removal step, the product is packaged in a hermetically sealed bag (step 135), described in more detail below, wherein a defined quantity of a processing aid solution is added to the bag (step 140). In some embodiments, the total quantity of the processing aid solution added is 5% and above of the total weight of the product being placed within the bag. The processing aids could include, without limitation the following: nisin, distilled water vinegar, vinegar, lemon juice, lemon juice concentrate, apple juice, apple juice concentrate, cumin seed, ginger, garlic, lactic acid, gluconic acid, malic acid, peroxyacetic acid, tartaric acid, acetic acid and its derivatives, sodium bisulfate, gluconodeltalactone (GDL), citric acid, buffers of such acids, oleoresins, vegetable oil (e.g., canola oil), truffle oil, onion extract, clove and clove extracts, paprika extracts, cumin and cumin extracts and the like. The processing aid solution might also require the addition of DI water or distilled water for dilution ranging from 0% to 80% weight basis of the total solution. After the addition of the processing aid ingredients along with the product, the bag is then closed and is optionally agitated (e.g. flipped a few times) to allow for the processing aid to get coated on product uniformly. As set forth in more detail below, closing the bags seals the product and any introduced processing aid in the bag while maintaining a carbon dioxide permeable barrier (a “breathable” portion).

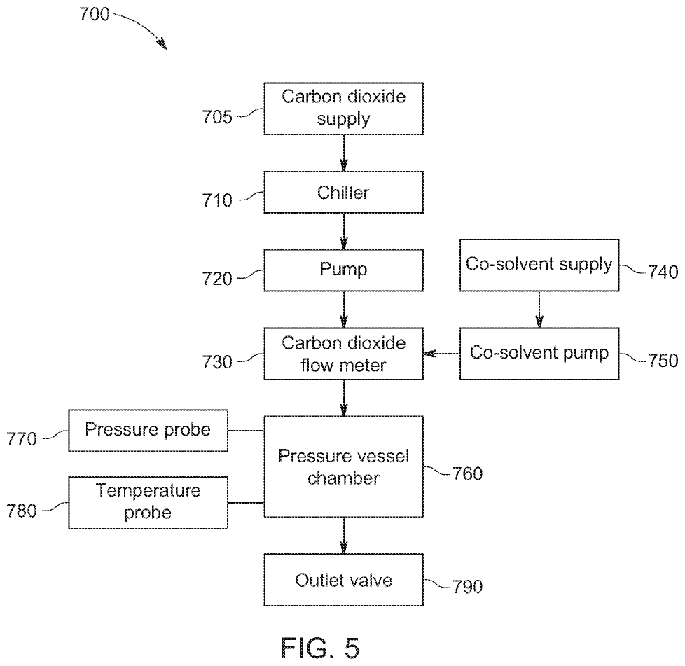

The sealed bags are then put inside the high pressure chamber 760 of system 700 shown in FIG. 5 (described in more detail below). The high pressure chamber is closed and the sealed bags are subjected to a supercritical carbon dioxide process (step 145). After completion of the supercritical carbon dioxide process, the bags are sealed to remove or enclose the carbon dioxide permeable barrier(s) (step 150). Next, the bags are cooled, e.g., by immersion in chilled water (step 155). In certain implementations, a temperature drop of 80-120° F. is achieved, which can result in a partial vacuum being formed in the bag. In some embodiments, this partial vacuum reduces the headspace (space not occupied by the potato product) within the bag, thereby reducing the moisture that is lost from the potato product to the headspace during storage. The processed potato product remains sealed in the packaging until use, including throughout storage.

### Supercritical Carbon Dioxide Process

FIG. 5 illustrates a system 700 used for performing various implementations of a supercritical carbon dioxide process according to embodiments of the invention. System 700 has a carbon dioxide supply/inlet tank (705) which is maintained at, e.g., 750 psi or above. The carbon dioxide from this inlet (705) goes through a carbon dioxide chiller (710). The chiller (710) is maintained at about −5° C., which allows the carbon dioxide to remain in liquid phase when exiting the inlet (705). Doing so increases the efficiency of a carbon dioxide pump (720), which is a positive displacement liquid pump. The output of pump (720) is measured by a carbon dioxide flow meter (730), which maintains a desired flow rate at which carbon dioxide is introduced into a chamber (760). The chamber (760) is a high pressure chamber into which product to be treated is placed and into which the carbon dioxide feed is passed.

The chamber (760) can have one or more openings to which the carbon dioxide is supplied. The same or additional openings may be used to remove the carbon dioxide. The system 700 also has a co-solvent supply unit (740) attached with a co-solvent pump (750), which, in some embodiments, is a high-performance liquid chromatography pump that can pump liquid co-solvents at a set flow rate against high pressures. The co-solvent pump (750) introduces co-solvent into the pressure chamber during the process cycle at a set flow rate. A pressure probe (770) provides pressure monitoring of the chamber (760) during the process cycle. Similarly, a temperature probe (780) provides temperature monitoring of the interior of the chamber (760) during the process cycle. Chamber (760) is connected to an outlet valve (790) for controlling the removal of the carbon dioxide from the chamber (760). In some embodiments, outlet valve (790) is a back pressure regulator valve that is opened when the system (700) is to be depressurized. The outlet valve (790) controls the swift and slow depressurization cycles by opening and closing as needed to maintain the desired depressurization rate, as described herein.

In one embodiment of the supercritical carbon dioxide process 145, the chamber (760) is flushed with carbon dioxide to purge air from the chamber 760. Next, the carbon dioxide is equilibrated within the chamber 760 to the carbon dioxide inlet pressure 705. After which outlet valve 790 is closed. Next carbon dioxide is fed into the chamber 760 at a temperature between about 88° F. and 250° F. The pump 720 is utilized to further pressurize the chamber 760. During the supercritical carbon dioxide process, the feed flow of carbon dioxide may be continuous (herein “continuous feed”) or may be stopped (herein “no feed”). Thus, the term “continuous” herein describes the dynamic flow of the carbon dioxide into the chamber (760) through-out the time period of the supercritical cycle run time. Flow meter 730 is utilized to measure and maintain the flow rate of the carbon dioxide in case of the continuous feed. Whereas the term “no feed” herein describes a condition in which no further carbon dioxide is fed into the chamber through-out the time period of the supercritical cycle run time. For the sake of clarity, whether the supercritical process is run under continuous feed or no feed conditions, the carbon dioxide is prevented from flowing out of the system (more specifically out of the chamber (760)) beyond the depressurization valve (790) until the cycle is complete.

The carbon dioxide feed into the system continues until a target system pressure is reached. The target system pressure can vary between 1070 psi and 7000 psi and depends on the final product and processing aids used in the process. In some embodiments of the invention, the appropriate target system pressure is selected by determining the minimum pressure at which the processing aids to be used in the supercritical carbon dioxide treatment are soluble in the supercritical carbon dioxide. For example, certain processing aids mentioned in this disclosure will be soluble in the supercritical carbon dioxide at higher pressures relative to other processing aids. This is so because the carbon dioxide has a relatively higher density at relatively higher operating pressures. This higher density enhances the carbon dioxide's solubilizing ability. Therefore, with the change in the processing aid being utilized in the process, the operating pressure may also change. The duration of the cycle during which the system pressure and temperature are maintained at the desired values can also vary depending on the processing aids, type of potato product, and thickness and width of cut of the cut potato product. In some implementations, the supercritical carbon dioxide process cycle temperature and pressure are maintained for about 30 seconds to about 60 minutes. In some implementations, the supercritical carbon dioxide process cycle temperature and pressure are maintained for about 30 seconds to about 50 minutes. In some implementations, the supercritical carbon dioxide process cycle temperature and pressure are maintained for about 30 seconds to about 40 minutes. In some implementations, the supercritical carbon dioxide process cycle temperature and pressure are maintained for about 30 seconds to about 30 minutes. In some implementations, the supercritical carbon dioxide process cycle temperature and pressure are maintained for about 30 seconds to about 20 minutes. In some implementations, the supercritical carbon dioxide process cycle temperature and pressure are maintained for about 30 seconds to about 10 minutes. In some implementations, the supercritical carbon dioxide process cycle temperature and pressure are maintained for about 30 seconds to about 5 minutes. In some implementations, the supercritical carbon dioxide process cycle temperature and pressure are maintained for about 30 seconds to about 4 minutes. In some implementations, the supercritical carbon dioxide process cycle temperature and pressure are maintained for about 30 seconds to about 3 minutes. In some implementations, the supercritical carbon dioxide process cycle temperature and pressure are maintained for about 30 seconds to about 2 minutes. In some implementations, the supercritical carbon dioxide process cycle temperature and pressure are maintained for about 30 seconds to about 1 minute. In some implementations, the supercritical carbon dioxide process cycle temperature and pressure are maintained for about 1 minute to about 5 minutes. In some implementations, the supercritical carbon dioxide process cycle temperature and pressure are maintained for about 5 minutes to about 10 minutes. In some implementations, the supercritical carbon dioxide process cycle temperature and pressure are maintained for about 8 minutes to about 12 minutes.

Once the cycle is complete, the system is depressurized by throttling outlet valve 790. In other embodiments, other valves may be included in the system design for accomplishing the depressurization. The depressurization cycle is performed in two steps. The first depressurization step is termed “swift cycle” and the second depressurization step is termed “slow cycle”. The term “swift cycle” herein refers to a quick depressurization action performed to change the state of the carbon dioxide from supercritical phase to gas phase to allow for no/minimal loss of the processing aid from the bag. This step of swift depressurization allows the state of the fluid to change which results in the separation of the processing aid from the fluid as the processing aid cannot remain solubilized in the gas phase of the fluid. Therefore, this step results in the deposition of the processing aid within the cellular structure of the potato product. In some implementations, the swift cycle depressurization rate is at 80 psi/sec-90 psi/sec. In some implementations, the swift cycle depressurization rate is at 90 psi/sec-100 psi/sec. In some implementations, the swift cycle depressurization rate is at 100 psi/sec-110 psi/sec. In some implementations, the swift cycle depressurization rate is at 110 psi/sec-120 psi/sec. In some implementations, the swift cycle depressurization rate is at 120 psi/sec-130 psi/sec. In some implementations, the swift cycle depressurization rate is at 130 psi/sec-140 psi/sec. In some implementations, the swift cycle depressurization rate is at 140 psi/sec-150 psi/sec. In some implementations, the swift cycle depressurization rate is at 150 psi/sec-300 psi/sec.

The time period of the swift cycle depressurization step is dependent upon the operating pressure of the process and the volume of the operating system. In some implementations, the swift cycle is conducted within 1 second to 1 minute. In other embodiments, the total swift cycle depressurization time is 1-5 seconds. In other embodiments, the total swift cycle depressurization time is 5-10 seconds. In other embodiments, the total swift cycle depressurization time is 10-15 seconds. In other embodiments, the total swift cycle depressurization time is 15-20 seconds. In other embodiments, the total swift cycle depressurization time is 20-25 seconds. In other embodiments, the total swift cycle depressurization time is 25-30 seconds. In other embodiments, the total swift cycle depressurization time is 35-40 seconds. In other embodiments, the total swift cycle depressurization time is 40-45 seconds. In other embodiments, the total swift cycle depressurization time is 45-50 seconds. In other embodiments, the total swift cycle depressurization time is 50-55 seconds. In other embodiments, the total swift cycle depressurization time is 55-60 seconds.

The term “slow cycle” herein refers to a slow depressurization action performed to get the pressure of the vessel (760) equal to atmospheric pressure which does not impair the integrity of the bag or the potato product inside. In one embodiment, the depressurization rate for the slow cycle is less than 80 psi/sec and is preferably about 2.5 psi/sec and conducted over 5 minutes. In other embodiments, the slow cycle depressurization rate is less than or equal to about 70 psi/sec. In other embodiments, the slow cycle depressurization rate is less than or equal to about 60 psi/sec. In other embodiments, the slow cycle depressurization rate is less than or equal to about 50 psi/sec. In other embodiments, the slow cycle depressurization rate is less than or equal to about 40 psi/sec. In other embodiments, the slow cycle depressurization rate is less than or equal to about 30 psi/sec. In other embodiments, the slow cycle depressurization rate is less than or equal to about 20 psi/sec. In other embodiments, the slow cycle depressurization rate is less than or equal to about 10 psi/sec. In other embodiments, the slow cycle depressurization rate is less than or equal to about 5 psi/sec. In other embodiments, the slow cycle depressurization rate is less than or equal to about 2.5 psi/sec.

The time period of the slow cycle depressurization step is dependent, in part, upon the pressure achieved by the swift cycle depressurization. In some implementations, the slow cycle is conducted within about 1 minute. In other embodiments, the total slow cycle depressurization time is 1-2 minutes. In other embodiments, the total slow cycle depressurization time is 2-3 minutes. In other embodiments, the total slow cycle depressurization time is 3-4 minutes. In other embodiments, the total slow cycle depressurization time is 4-5 minutes. In other embodiments, the total slow cycle depressurization time is 5-6 minutes. In other embodiments, the total slow cycle depressurization time is 6-7 minutes. In some embodiments, the depressurization rates for both the swift cycle and slow cycle are maintained at about a constant rate. In other embodiments, the depressurization rates describe the total pressure drop during a measured time period, and the rate of change of pressure during the depressurization step need not be constant during the depressurization cycles.

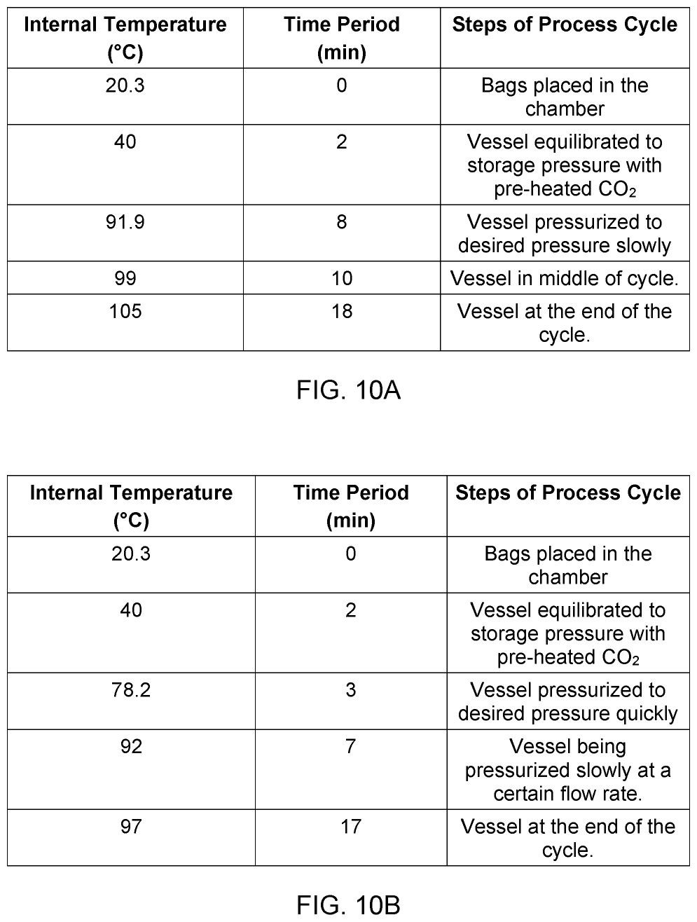

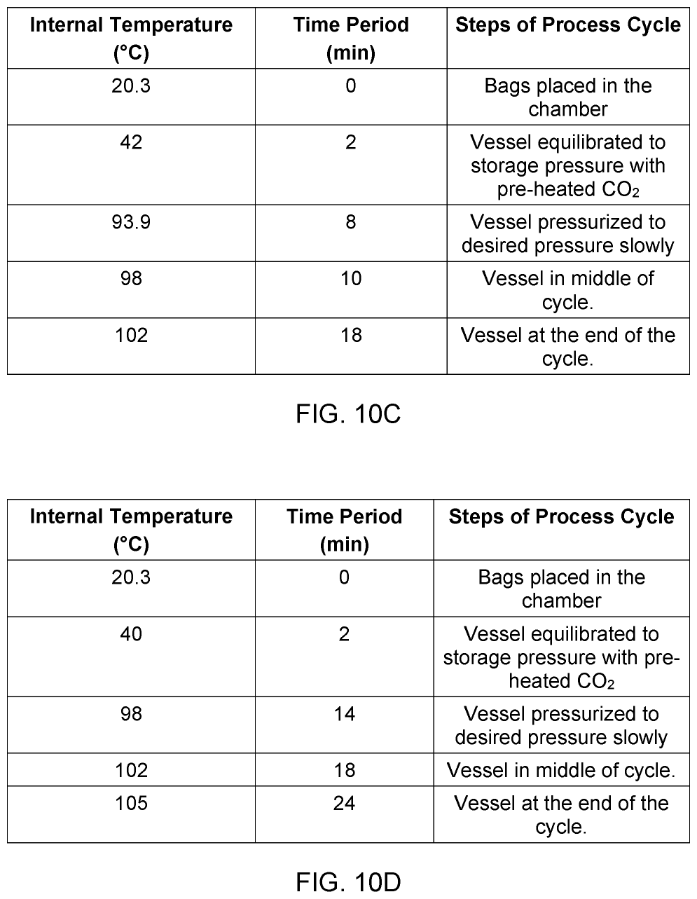

This processing technique of treating the product within the high pressure environment of supercritical carbon dioxide increases its ability to solubilize various processing aids. Hence the fluid acts as a transportation medium for such processing aids/ingredients as it moves into the bag. In addition, the carbon dioxide can be heated to a desired temperature to achieve the correct/appropriate diffusivity within a range of operating pressure. This aspect of the process allows one to attain a desired internal temperature of the product to achieve the commercial sterility within the pre-packaged product very swiftly, which in turn results in minimum damage to the textural and organoleptic properties of the product. Referring to FIG. 5, temperature probe 770 was inserted into the cross-sectional center of chamber 760 after a bag filled with the potato product was loaded into the chamber, thereby positioning the temperature probe in the potato product. The intention here was to record the temperature within the potato product inside the bag while the supercritical process was ongoing. FIGS. 10A-10D show the rate of internal temperature rise to 195° F. from the initial room temperature which is required to prove commercial sterility. There is no adverse effect to the texture of the potato product after being subjected to the supercritical carbon dioxide processing described herein. Specifically, the potato pieces hold their original structure/shape after being treated by the process. Embodiments of the inventive process achieve these results in part due to the relatively short amount of processing time needed to achieve the required temperature resulting from the direct contact between the product and the heating medium (the pre heated carbon dioxide with the product).

### Product Bags and Sealing Steps

As described herein, products are sealed into bags before being exposed to a supercritical carbon dioxide process. Portions of these bags that hold the product for supercritical carbon dioxide processing and/or for holding the product post-processing are described as “breathable” while other portions are said to be “non-breathable.” Breathable portions are permeable to the supercritical fluid under the supercritical process conditions and may, optionally, be permeable to air and water vapor under standard conditions (e.g., ambient temperature and pressure) but not to microorganisms. Meanwhile, the non-breathable portions remain impermeable to fluids under the supercritical process conditions and under standard conditions. Examples of breathable materials include, without limitation, TYVEK® 1073B, TYVEK® 1059B, and TYVEK® 40L. Meanwhile, examples of non-breathable materials include linear low-density polyethylene (LLDPE).

TYVEK® 1073B, with a thickness of 7 mils, and 1059B, with a thickness of 6.1 mils, have a typical Gurley Hill Porosity of 22 sec/100 cc, with a range of 8-36 sec/100 cc as measured using the TAPPI T460 test method. TYVEK® 40L, with a thickness of 5 mils, has a typical Gurley Hill Porosity of 6 sec/100 cc as measured using the TAPPI T460 test method and a nominal Bendtsen Air Permeability of 2350 mL/min, with a range of 700-4000 mL/min, as measured using the ISO 5636-3 test method.

One specific example of a non-breathable LLDPE material is SteriFlex 903 (by SteriPax of Huntington Beach, Calif.). SteriFlex 903, with a thickness of 3 mils, has an oxygen transmission rate and water vapor transmission rate of about zero as measured by the ASTM D-1434 and ASTM F-1249 test methods, respectively. Other non-limiting examples of materials for the non-breathable material include low-density polyethylene, polyethylene, polyethylene terephthalate, ethylene-vinyl acetate, nylon, and multi-layer combinations of such materials. Suitable thicknesses of the material can be thicker or thinner than 3 mils and include, without limitation, thickness ranging from 2-3.5 mils.

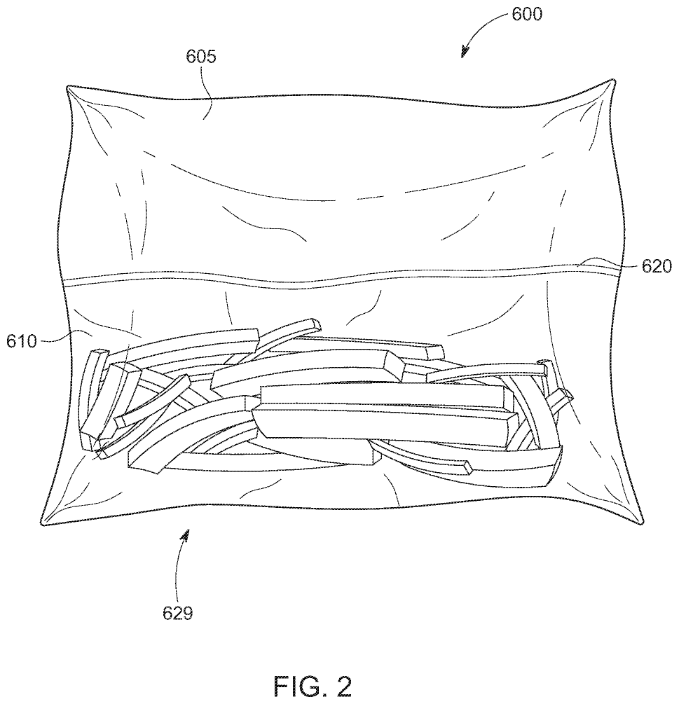

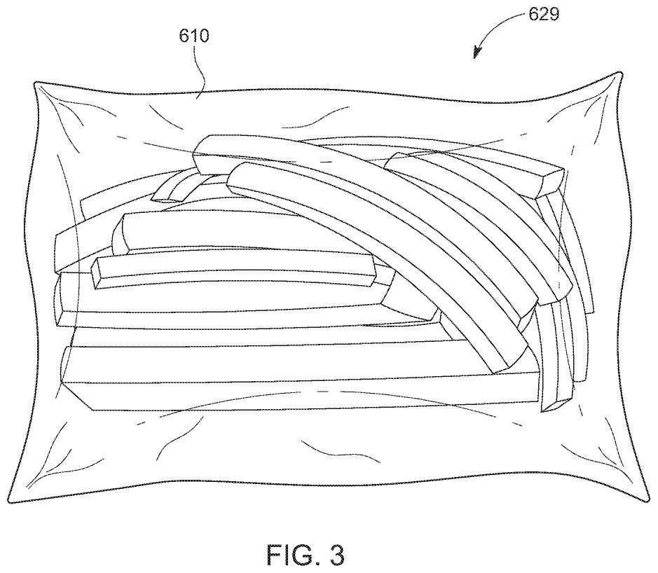

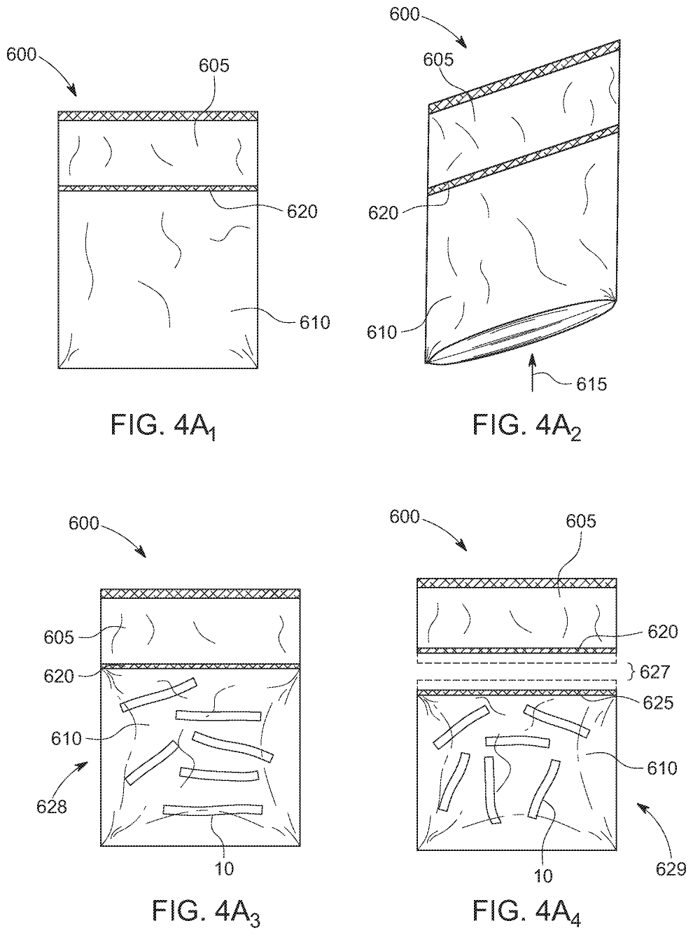

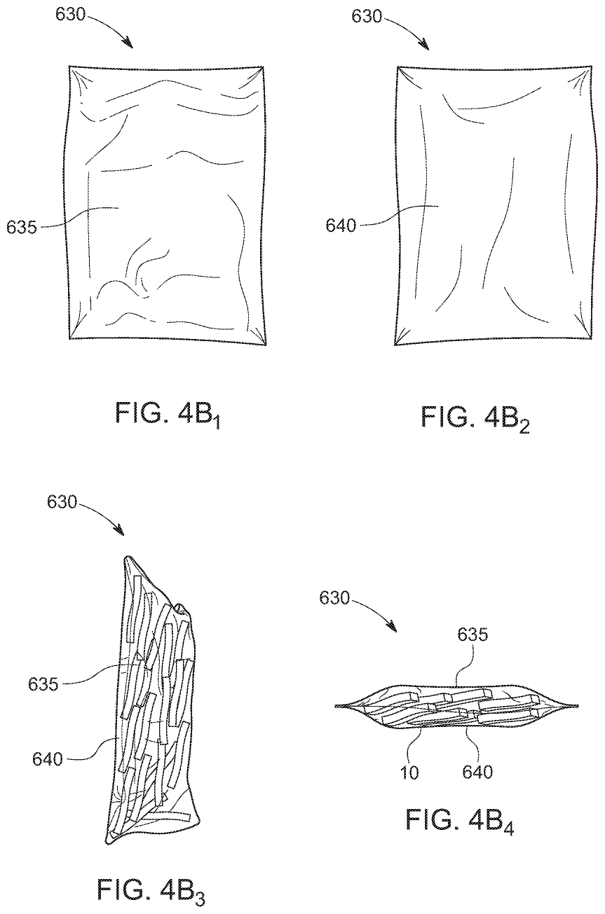

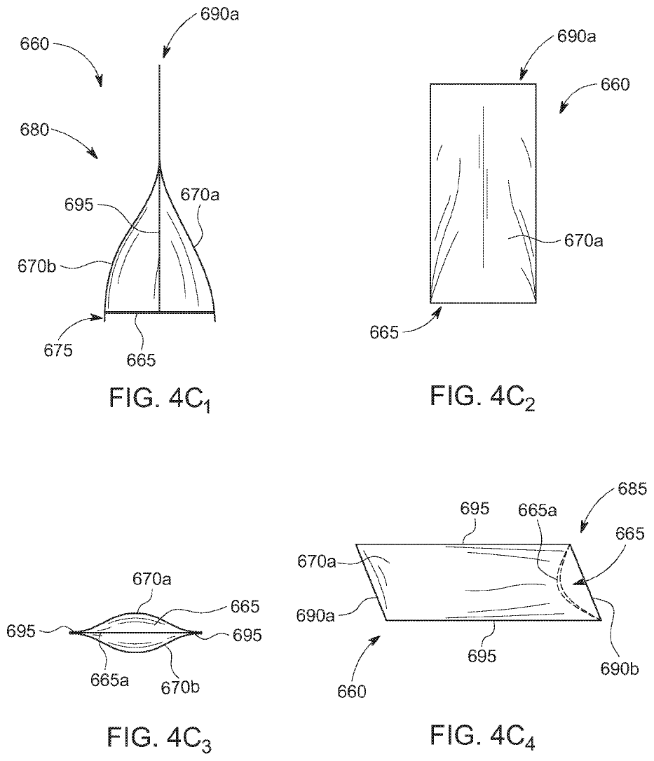

One embodiment of such a bag 600 (hereafter also referred to as “bag 1”) is shown in FIGS. 4A₁-4A₄. Bag 600 has a first breathable section 605, while the remainder of the bag is made from non-breathable material 610. Product to be treated while enclosed within bag 1 (e.g., French fries 10, or more generally potato segments, a cut potato product, or the like; only a representative number of French fries 10 being shown in FIGS. 4A₃ and 4A₄) is loaded into an open end 615, and the open end 615 is then sealed, e.g., by melting closed (e.g., via heat sealing or any other similar technique) the opening of the non-breathable material 610. When using bag 1 in embodiments of the supercritical carbon dioxide process, after the chamber is depressurized, the bag is taken out from the chamber, the bag is flipped, and a seal 625 is made underneath the junction 620 between the breathable section 605 and the non-breathable material 610, as the section of non-breathable material 610 has sufficient volume to house the product that has already been treated. The section containing the breathable material 605 is then cut (at 627) from the section holding the treated product (FIG. 4A₄). Thus, bag 1 has a first processing configuration 628 (e.g., FIG. 4A₃) and a second post-processing storage configuration 629 (FIG. 4A₄). FIG. 2 is a sketch of bag 1 with product (e.g., potato segments, cut potato product, French fries, or the like) after processing (e.g., in accordance with FIG. 4A₃). FIG. 3 is a sketch of bag 1 after the breathable strip is sealed and cut from the bag and the bag was cooled by immersion in chilled water (e.g., in accordance with FIG. 4A₄). The temperature drop of 80-120° F. is achieved via this step which results in partial vacuum formation within the bag (the partial vacuum formation not being shown in FIG. 4A₄).

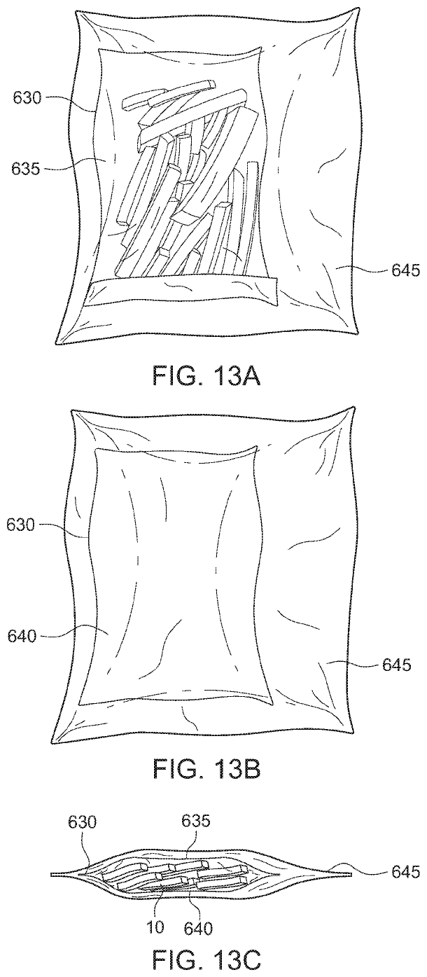

Another embodiment (“bag 2”) 630 is shown in FIGS. 4B₁-4B₄. Bag 2 has one side made of non-breathable material 635 (e.g., a panel or sheet formed from a non-breathable material, and which may be transparent (e.g., FIG. 13A)) joined to another side of breathable material 640 (e.g., a panel or sheet formed from a breathable material, and which may be opaque (e.g., FIG. 13B)). When using bag 2, after removal from the supercritical chamber, the bag is placed in another bag 645 made from non-breathable material followed by making a seal on the non-breathable bag with the breathable bag 2 thereby being enclosed inside, as shown in FIGS. 13A-13C (e.g., a bag-in-a-bag configuration, where the outer bag is non-breathable and where at least part of the inner/enclosed bag is breathable). An alternative embodiment of bag 2 is a bag made completely of the breathable material.

Another embodiment (“bag 3”) 660 is shown in FIGS. 4C₁-4C₄. Bag 3 has a gusseted area or foldable bottom panel 665 made of a breathable material (and which may incorporate a fold line 665a), while the remainder of the bag 3 is formed from a non-breathable material. A pair of sheets or panels 670a, 670b may be sealed together along a pair of sides 695 of bag 3 and are each formed of the noted non-breathable material. Bag 3 includes an end 690a that is opposite of the bottom panel 665, that is open to allow for introduction of product into the bag 660 (e.g., by the panels 670a, 670b not being sealed at the end 690a for product loading), and that is thereafter closed or sealed for processing of product while enclosed within bag 3 (e.g., by sealing the panels 670a, 670b together at the end 690a). The storage volume of bag 3 shown in FIG. 4C₁ can increase by increasing the spacing between the panels 670a, 670b up to the end 690a.

The bottom panel 665 is at least generally in the configuration shown in FIG. 4C₃ when the product is being processed in bag 3. In some embodiments, bag 3 would consist of at least 45 sq inches of breathable material for the bottom panel 665 for a bag that will contain 5 pounds of potatoes, that is placed at the bottom end of the bag sealed with the polymer to form a gusseted bag. Such a design results in the ability for the bag to stand up when placed within the processing system (e.g., by disposing the bottom panel 665 on an appropriate supporting surface within a processing chamber) and having the ability to breathe (allow carbon dioxide gas to enter and exit) via the bottom panel 665 during pressurization and de-pressurization.

After removal from the supercritical system, bag 3 is sealed by joining the ends of the polymer material to enclose the breathable material within bag 3. In this regard, the breathable material of the bottom panel 665 of the bag can be pushed inside in an “A” shape to create a flat bag from the original stand-up pouch (e.g., by folding the bottom panel 665 along the noted fold line 665a). The bag may have extra polymer extensions 675, measuring about 0.1 mm to 5 mm, around the joint between the breathable and non-breathable portions of the bag. The polymer extensions 675 can be utilized for making new seals between the polymers of both sides of the non-breathable portions of the bag (e.g., by sealing the panels 670a, 670b together to define a sealed end 690b for bag 3-FIG. 4C₄) after the processing to seal the breathable material, namely the bottom panel 665, within the interior of bag 660 (e.g., such that the bottom panel 665 no longer defines an exterior of bag 3). Thus, embodiments of bag 3 can include, without limitation, two configurations: a first configuration 680 for use during supercritical carbon dioxide processing in which breathable material (bottom panel 665) forms an outer surface of the bag 3 (e.g., FIG. 4C₁) and a second configuration 685 in which all breathable material (bottom panel 665) is entirely enclosed within non-breathable material for a post-processing state or condition (FIG. 4C₄) and including for a storage configuration. As shown in FIG. 4C₄, the entirety of the breathable material (bottom panel 665) is tucked inside non-breathable material (within a sealed perimeter between the panels 670a, 670b), which has been sealed at end 690b (the panels 670a, 670b also having been previously sealed along both sides 695 and at the end 690a).

The first configuration of bag 3 results in a desirable orientation of the bags within the processing chamber as they can stand up within the chamber. This orientation prevents the breathable material of adjacent bags from interfering with each other as the bags are placed beside each other in the chamber. Also, having the breathable material within the bottom panel 665 of bag 3 results in a smaller bag dimension relative to, e.g., bag 1 of the same capacity (FIGS. 4A₁-4A₄). The required amount of polymer material gets reduced compared to the design/format discussed for bag 1 (FIGS. 4A₁-4A₄) as there will be no need to cut out the breathable area which would result in the loss of polymer material as well. Similarly, this would also not require a secondary packaging like the bag 2 design/format (FIGS. 4B₁-4B₄ and FIGS. 13A-13C) as the breathable material would be enclosed within the final configuration for bag 3 and sealed off in its second configuration 685. Therefore, this format can result in cost savings for the material while still utilizing sufficient breathable material to avoid bursting of the bags during the process and having an efficient process.

### EXAMPLES

The following examples are intended to illustrate particular embodiments of the present disclosure, but are by no means intended to limit the scope of the present disclosure.

### Example 1

The following illustrative example of the processes described herein produced a potato product. Whole potatoes were sized to the desired raw material of 65 mm in length. The sized potatoes were washed and cut into size of ⅜ inch width and thickness using a hand french fry cutter. The cut product was washed again in cold water to remove the excess starch. The sample size of washed and cut potato ready for further processing was 500 gram. The variety of the potato being used for this example was Lamoka which has a dry matter of about 21-22%.

The cut product was then blanched in hot water bath solution. The blanching solution consisted of GDL—gluconodeltalactone and citric acid at about 0.3% weight and 0.15% weight, respectively, of the total solution. The temperature of the blanching solution was about 180° F. The potatoes were blanched in the solution for about 15 minutes.

After blanching the potatoes were put into a batter solution which was maintained at a chilled temperature of about 42° F. The thin batter solution consisted about 58% moisture and 42% of the following ingredients: corn starch, rice flour, all-purpose flour, salt and glucose. The ratio of the ingredients was about 2:1:1:0.2:0.5 weight basis. The product was dipped into the batter solution for about 45 seconds. The weight of the batter solution was taken before the dipping exercise was performed and the weight after the dipping of the product was taken. The difference in the weight allowed for the calculation of the batter pick up by the product. It was calculated that at this viscosity the batter pick up was around 7-9% weight basis.

After the battering step the product was put through an oven cooking step wherein the temperature of cooking was at 350° F. The residence time for the product was about 3 minutes. The amount of moisture removal that occurred during the step was about 7-9%.

After the product was taken out from the oven it was directly placed within the hermetically sealed bags as shown in FIGS. 4A₁-4A₄. These bags are made using a film made from a combination of nylon and PET. In this format, this film is attached with the TYVEK® strip or a patch to make it into a bag where in the TYVEK® is placed on one side of the one end of the bag as shown in FIGS. 4A₁-4A₄. The processing aid solution was added to the bag. In this example, the processing aid solution included distilled white vinegar of 5% acidity, Garlic Extract, Cumin Extract, DI water in the ratio of 3:1:1:2 weight basis. The quantity of the solution added was about 7% of the total product before adding the solution. The bag was sealed and these sealed bag/s were placed inside the high pressure chamber. The bags are placed within the chamber in an orientation such that breathable part is not blocked.

The high pressure chamber (5 liter) was sealed and the process of flowing the CO₂ into the chamber was started. The temperature of the CO₂ at the inlet is above 195° F. The CO₂ was first equilibrated to the CO₂ storage pressure of 750 psi after which the further pressure within the chamber is built up by supplying CO₂ to a pump/compressor that pressurizes the carbon dioxide within the chamber. For this example a no feed process was used. Therefore the chamber was pressurized to a value of 2500 psi in 8 minutes and then the feed flow was stopped. In other embodiments, the operating range for use with these processing aids is between 2300 psi to 3000 psi. As shown in FIG. 10A, the rise of the temperature within the chamber was being recorded. After an internal temperature of 195° F. was maintained for 10 minutes (required to achieve commercial sterility), the system was depressurized. The process of depressurization was done in two steps. The first step was a swift cycle depressurization step wherein the average rate of depressurization was about 80 psi/sec, until reaching about 500 psi, and the remainder of the depressurization (e.g., to about atmospheric pressure) was done at less than about 2.5 psi/sec on average for the entire slow depressurization.

After the complete depressurization of the chamber the bag was taken out and the probe was inserted into a random sample inside the bag to check for the internal temperature and the temperature was recorded at 92° C. The net weight of the product within the packaging was measured to be 500 gram. The net weight was calculated by subtracting the weight of the empty bag from the gross weight after processing.

The bag was oriented so that the product was in the bag away from the breathable strip and the seal was made underneath the breathable strip of the bag using a heat sealer to melt the polymer material, as shown in FIG. 2. FIG. 3 shows the bag after the bag is sealed below the breathable strip and the strip is cut from the bag. The bag in FIG. 3 was cooled by immersion in chilled water. A temperature drop of 80-120° F. is achieved via this step which results in minimizing the headspace as a result of partial vacuum formation within the bag due to the differential pressure between the inside and outside of the bag.

After the bag was cooled, it was opened and random samples were taken. These random samples were 2-3 pieces of potato french fry that were about 0.5-1.0% weight basis of the total sample within the bag. These samples were the standard 3/8 inch width and thickness french fry samples from the processed bag which were mashed and were made into a slurry. The equilibrium pH of the slurry was 4.22 compared to the raw unprocessed potato, which was 6.3. Similarly, another random sample from the bag was taken. These random samples were 2-3 pieces of potato french fry that were about 0.5-1.0% weight basis of the total sample within the bag. These samples were the standard ⅜ inch width and thickness french fry samples from the processed bag. The cross-sectional center of the sample was cut out and was made into a slurry. The cross section of the sample was determined by removing the sides of the cuboid structure to form a cross sectional center of 3/16 inch width and thickness, which was mashed into a slurry. The equilibrium pH of the slurry was 4.23.

In addition, various potato samples were prepared as set forth above and were individually placed in hermetically sealed bags with each bag having 27 ml of processing aid along with around 500 grams of product. These samples were processed according to supercritical carbon dioxide step of the process above for different time intervals ranging from 1 minute to 20 minutes. As shown in FIG. 9, embodiments of the current invention's processing technique allows for the processing aid to be infused very swiftly and be retained in the product within a minute. This shows that the rate of infusion remains constant despite the longer process times. Hence, one benefit of the process is in how the process utilizes the unique the two-step depressurization process. Second, this shows the process allows for the proper diffusivity of the solubilized processing aid into the cross-sectional center of the product very swiftly.

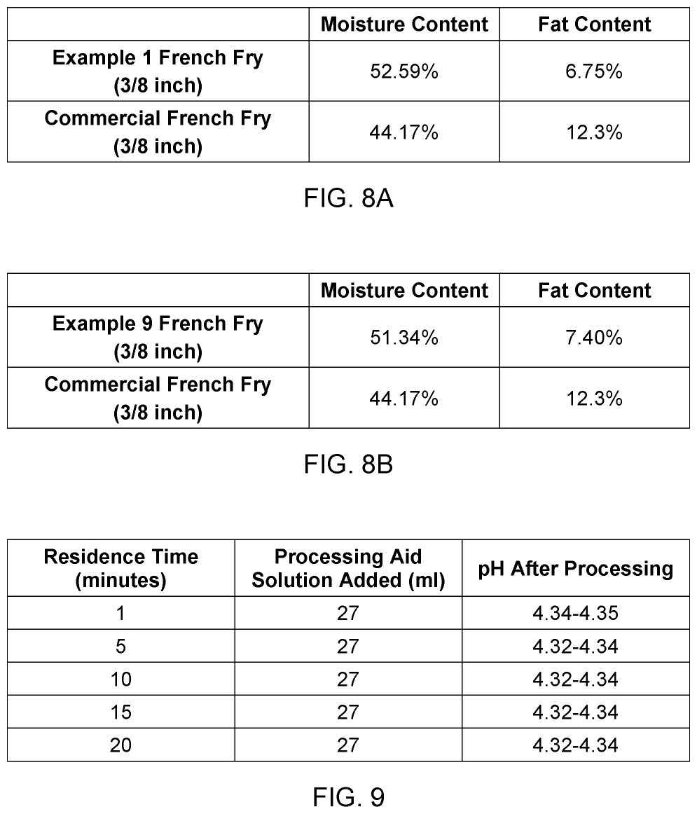

Other bags treated according to the process above were left sealed and stored at room temperature for a 10 days, after which random samples were taken from the bag. These random samples were 2-3 pieces of potato french fry that were about 0.5-1.0% weight basis of the total sample within the bag. These samples were the standard 3/8 inch width and thickness french fry samples from the processed bag, which were fried in canola oil at a temperature of 350° F. for 3 minutes. Frozen french fry samples were also fried in canola oil at the same temperature and for the same amount of time. In other embodiments, the samples would be fried in canola oil for about 4 minutes. The product samples and the frozen french fry samples were analyzed for moisture and fat content analysis. The methodology referenced for the determining the fat content was AOAC 933.05 and the methodology referenced for the determining the moisture content was AOAC 984.25. The results of moisture and fat content testing are shown in FIG. 8A. The post-frying moisture content of the samples processed according to the embodiment of the current invention described above is higher than the frozen french fry and the fat content is 50% less compared to the frozen french fry samples. Thus, the post-frying fat to moisture ratio of the samples produced according to an embodiment of the invention is lower than the frozen french fry control.

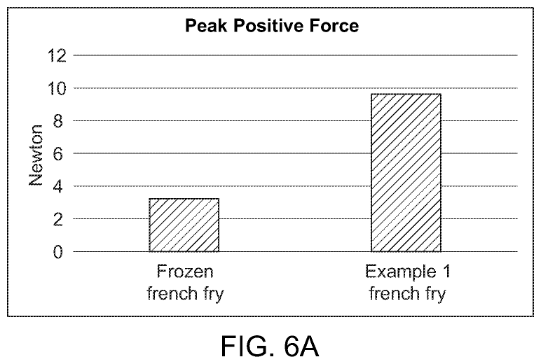

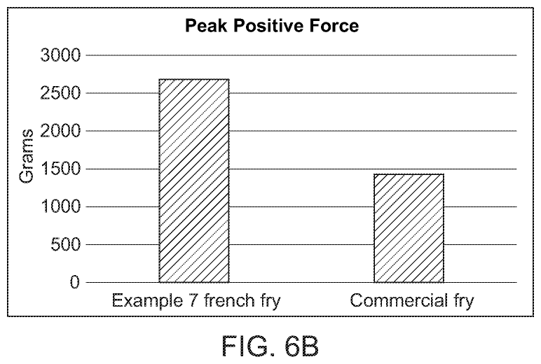

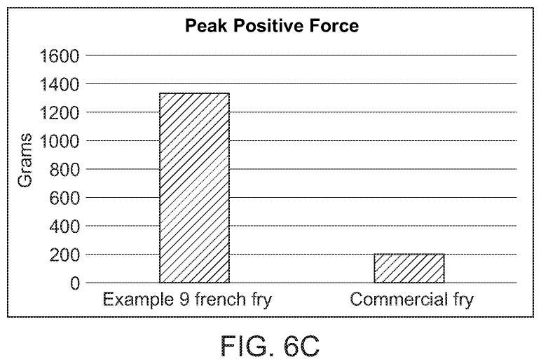

Similarly, a puncture test was performed on four random samples of the french fry product produced by the embodiment of the invention described above along with controls of frozen french fries of ⅜ inch width and thickness. The puncture test measured the surface hardness of the test samples. These samples were analyzed 2 minutes after frying according to the temperature and time above. The puncture test determined the peak force required to puncture the outer skin of the fried product with a 3 mm probe at test speed of 2 mm/sec. Four punctures were performed at four different locations on each sample. FIG. 6A shows the results of the puncture testing, which reveals that french fries produced according to the embodiment of the process described above had a 2.5 times higher peak force compared to the frozen french fry. This shows that despite of the higher moisture and less fat in the inventive product, it still has a harder exterior surface which results in the crispier exterior.

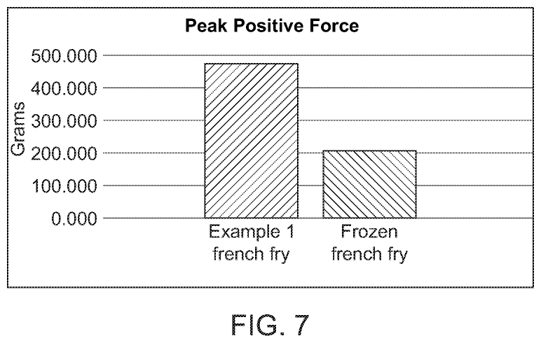

Similarly, a puncture test was performed on four random samples of the inventive french fry product along with controls of frozen french fries according to the protocol above. These samples were analyzed 20 minutes after the frying using the puncture test described above and the average value of the 16 readings was plotted in FIG. 7. The highest value within the range was recorded at 700 grams and minimum value at 338 grams peak positive force. FIG. 7 shows the results of the puncture testing, which reveals that the inventive french fry product had a 2 times higher peak force compared to the frozen french fry (about 475 grams for the example 1 product versus about 200 grams for the frozen product). This shows that the inventive french fry has a better hold time compared to the frozen counterpart.

Samples were tested for Microbial growth, both mold and bacteria. The procedure followed for conducting the shelf life studies is described below:

### Media Preparation:

PDA: 15 grams of potato dextrose agar was mixed in 1 liter of deionized water. It was mixed well, then autoclaved at 121° C. cycle. The media was then poured into the petri plates and stored in the refrigerator at 4-7° C. until used.

PCA: 15 grams of agar media was mixed in 1 liter of deionized water. It was mixed well, then autoclaved at 121° C. cycle. The media was then poured into the petri plates and stored in the refrigerator at 4-7° C. until used.

Peptone Water: 15 grams of peptone was mixed in 1 liter of deionized water. It was mixed well, then it was poured into 10 ml test tubes and 25 ml screw caped test tubes. These were autoclaved at 121° C. cycle. In each 10 ml test tube 9 ml of peptone water was poured for the serial dilution. And in the 25 ml ones, 20 ml was poured which were used for the stomaching the samples before plating.

For molds, the procedure/methodology described in Bacteriological Analytical Manual, Tournas, Stack, Mislivec, & Bandler. (8^{th} Ed. 1998) for yeasts, molds and mycotoxins was referenced.

### Microbial Activity Determination:

Samples stored for a certain number of days were opened up and placed into the stomacher bag and the 20 ml of peptone water was added to it. Then these samples were placed in the stomacher for 3 min at 250 rpm. Then 1 ml of the peptone solution was pipetted out from the bag and was added to the 9 ml test tube of peptone water. Serial dilutions were done up to 10⁻⁶ maximum. Then 1 ml of the solution was pipetted out of the serial diluted tube 10⁻⁶ which were emptied into three petri plates of the PDA and PCA respectively. It was spread uniformly around the whole plate and was stored at the 30° C. for 48 hours to calculate the total plate count using the below formula:

Initial dilution*subsequent dilution*amount plated=dilution factor

Reciprocal of dilution factor*colonies formed=cfu/gm

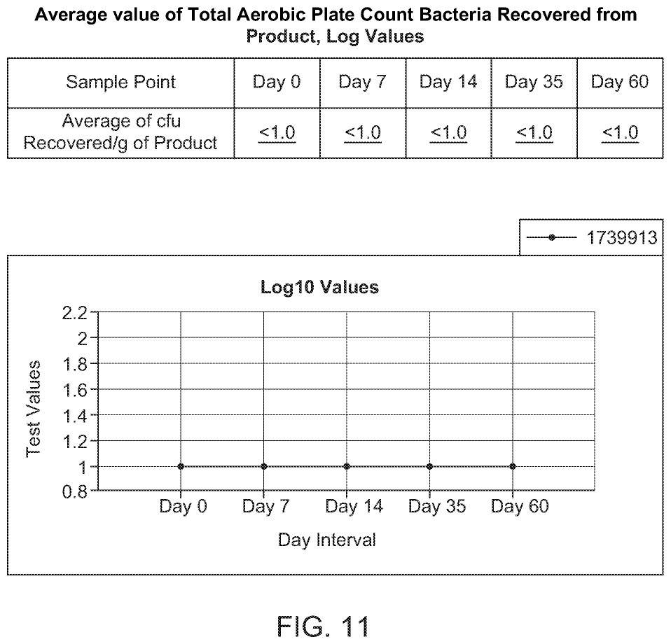

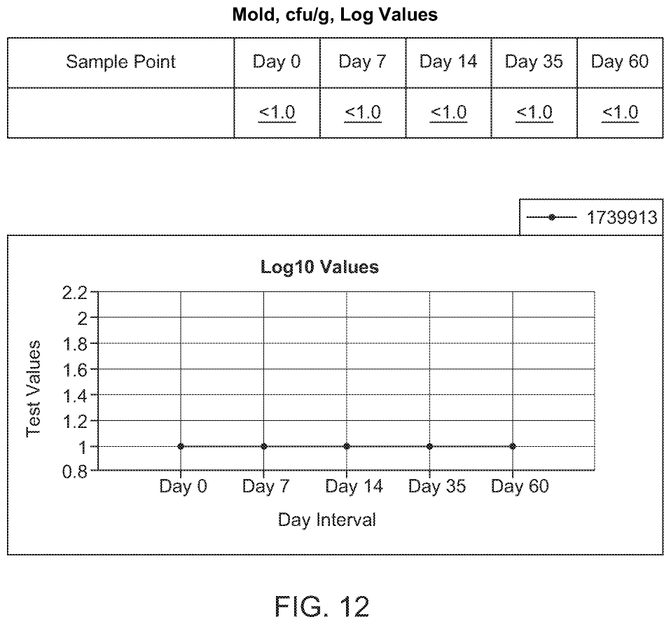

As shown in the FIGS. 11 and 12, there was no growth of bacteria or mold seen in the product, suggesting that the process results in achieving the commercial sterility. Specifically, for samples taken at days 7, 14, 35, and 60, it was found that no colony forming units of bacteria or mold/gram of product sampled existed in the processed potato product.

### Example 2

The following illustrative example of the processes described herein produced a potato product. Whole potatoes were sized to the desired raw material of 65 mm in length. The sized potatoes were washed and cut into size of ⅜ inch using a hand french fry cutter. The cut product was washed again in cold water to remove the excess starch. The sample size of washed and cut potato ready for further processing was 900 gram. The variety of the potato being used for this example was Kennebec which has a dry matter of about 20%.

The cut product was then blanched in hot water bath solution. The blanching solution consisted of GDL—gluconodeltalactone and citric acid at about 0.3% weight and 0.15% weight, respectively, of the total solution. The temperature of the blanching solution was about 180° F. The potatoes were blanched in the solution for about 15 minutes.

After blanching the potatoes were put into a batter solution which was maintained at a chilled temperature of about 42° F. The thin batter solution consisted about 58% moisture and 42% of the following ingredients: corn starch, rice flour, all-purpose flour, salt and glucose. The ratio of the ingredients was about 2:1:1:0.2:0.5 weight basis. The product was dipped into the batter solution for about 45 seconds. The weight of the batter solution was taken before the dipping exercise was performed and the weight after the dipping of the product was taken. The difference in the weight allowed for the calculation of the batter pick up by the product. It was calculated that at this viscosity the batter pick up was around 7-9% weight basis.

After the battering step the product was put through an oven cooking step wherein the temperature of cooking was at 350° F. The residence time for the product was about 3 minutes. The amount of moisture removal that occurred during the step was about 7-9%.

After the product was taken out from the oven it was directly placed within the hermetically sealed bags as shown in FIGS. 4A₁-4A₄. These bags are made using a film made from a combination of nylon and PET. In this format, this film is attached with the TYVEK® strip or a patch to make it into a bag where in the TYVEK® is placed on one side of the one end of the bag as shown in FIGS. 4A₁-4A₄. The processing aid solution was added to the bag. In this example, the processing aid solution included distilled white vinegar of 5% acidity, Garlic Extract, Cumin Extract, DI water in the ratio of 3:1:1:2 weight basis. The quantity of the solution added was about 7% of the total product before adding the solution. The bag was sealed and these sealed bag/s were placed inside the high pressure chamber. The bags are placed within the chamber in an orientation, such that breathable part is not blocked.

The high pressure chamber (5 liter) was sealed and the process of flowing the CO₂ into the chamber was started. The temperature of the CO₂ at the inlet is above 195° F. The CO₂ was first equilibrated to the CO₂ storage pressure of 750 psi after which the pressurization cycle was started. For this example a continuous cycle was operated. Therefore chamber was pressurized quickly to the supercritical state of a pressure of 2300 psi then for the remainder time, the carbon dioxide was added slowly at a flow rate of 20-25 grams/min introduced into the chamber with the same compressor by manually controlling the rate of compression. The chamber was initially pressurized to 2300 psi in one minute. The operating range for use with these processing aids is between 2300 psi to 3000 psi. By the end of the cycle the pressure achieved within the chamber was around 2700 psi. As shown in FIG. 10B, the rise of the temperature within the chamber was being recorded. After an internal temperature of 195° F. was maintained for 10 minutes, the process of depressurization was done in two steps. The first step was a swift cycle depressurization step wherein the average rate of depressurization was about 100 psi/sec, until about 700 psi was reached, and the remainder of the depressurization (e.g., to about atmospheric pressure) was done at less than about 2.5 psi/sec on average for the entire slow depressurization. The net weight of the product within the packaging was measured to be 900 gram. The net weight was calculated by subtracting the weight of the empty bag from the gross weight after processing.

The bag was oriented so that the product was in the bag away from the breathable strip and the seal was made underneath the breathable strip of the bag using a heat sealer similar to that shown in FIG. 2. A temperature drop of 80-120° F. was achieved via immersion in chilled water, which results in minimizing the headspace as a result of partial vacuum formation within the bag due to the differential pressure between the inside and outside of the bag.

### Example 3

The following illustrative example of the processes described herein produced a potato product. Whole potatoes were sized to the desired raw material of 65 mm in length. The sized potatoes were washed and cut into size of ⅜ inch using a hand french fry cutter. The cut product was washed again in cold water to remove the excess starch.

The cut product was then blanched in hot water bath solution. The blanching solution consisted of GDL—gluconodeltalactone and citric acid at about 0.3% weight and 0.15% weight, respectively, of the total solution. The temperature of the blanching solution was about 180° F. The potatoes were blanched in the solution for about 15 minutes.

After the step of blanching the product was directly placed within the hermetically sealed bags as shown in FIGS. 4A₁-4A₄. These bags are made using a film made from a combination of nylon and PET. In this format, this film is attached with the TYVEK® strip or a patch to make it into a bag where in the TYVEK® is placed on one side of the one end of the bag as shown in FIGS. 4A₁-4A₄. The processing aid solution was added to the bag. In this example, the processing aid solution included distilled white vinegar of 5% acidity, Garlic Extract, Cumin Extract, DI water in the ratio of 3:1:1:2 weight basis. The quantity of the solution added was about 7% weight of the total product before adding the solution. The bag was sealed and these sealed bag(s) were placed inside the high pressure chamber. The bags were placed within the chamber in an orientation such that breathable part is not blocked.

The high pressure chamber (5 liter) was sealed and the process of flowing the CO₂ into the chamber was started. The temperature of the CO₂ at the inlet is above 195° F. The CO₂ was first equilibrated to the CO₂ storage pressure of 750 psi after which the further pressure within the chamber is built up by supplying CO₂ to a pump/compressor that pressurizes the carbon dioxide within the chamber. For this example a no feed process was used. Therefore the chamber was pressurized to a value of 2500 psi in 8 minutes and then the feed flow was stopped. In other embodiments, the operating range for use with these processing aids is between 2300 psi to 3000 psi. As shown in FIG. 10C, the rise of the temperature within the chamber was being recorded. After an internal temperature of 195° F. was maintained for 10 minutes, the system was depressurized. The process of depressurization was done in two steps. The first step was a swift cycle depressurization step wherein the average rate of depressurization was about 80 psi/sec until about 500 psi was reached and the remainder of the depressurization (e.g., to about atmospheric pressure) was done at less than about 2.5 psi/sec on average for the entire slow depressurization.

After the complete depressurization of the chamber the bag was taken out and the probe was inserted into a random sample inside the bag to check for the internal temperature and the temperature was recorded at 92° C.

The bag was oriented so that the product was in the bag away from the breathable strip and the seal was made underneath the breathable strip of the bag with a heat sealer. A temperature drop of 80-120° F. was achieved via immersion in chilled water, which results in minimizing the headspace as a result of partial vacuum formation within the bag due to the differential pressure between the inside and outside of the bag.

### Example 4

The following illustrative example of the processes described herein produced a potato product. Whole potatoes were sized to the desired raw material of 65 mm in length. The sized potatoes were washed and cut into size of ⅜ inch using a hand french fry cutter. The cut product was washed again in cold water to remove the excess starch.

After the step of cutting and washing the product was directly placed within the hermetically sealed bags as shown in FIGS. 4A₁-4A₄. These bags are made using a film made from a combination of nylon and PET. In this format, this film is attached with the TYVEK® strip or a patch to make it into a bag where in the TYVEK® is placed on one side of the one end of the bag as shown in FIGS. 4A₁-4A₄. The processing aid solution was added to the bag. In this example, the processing aid solution consisted of distilled white Vinegar, Garlic Extract, Cumin Extract, DI water, GDL, Citric Acid in the ratio of 3:1:1:2:4:2 weight basis. The quantity of the solution added was about 15% weight of the total product before adding the solution. The bag was sealed and these sealed bag/s were placed inside the high pressure chamber.

The high pressure chamber (5 liter) was sealed and the process of flowing the CO₂ into the chamber was started. The temperature of the CO₂ at the inlet is above 195° F. The CO₂ was first equilibrated to the CO₂ storage pressure of 750 psi after which the further pressure within the chamber is built up by supplying CO₂ to a pump/compressor that pressurizes the carbon dioxide within the chamber. For this example a no feed process was used. Therefore the chamber was pressurized to a value of about 3500 psi in 9 minutes and then the feed flow was stopped. In other embodiments, the operating range for use with these processing aids is between 3000 psi to 3800 psi. As shown in FIG. 10D, the rise of the temperature within the chamber was being recorded. After a temperature of 195° F. was maintained for 10 minutes, the system was depressurized. The process of depressurization was done in two steps. The first step was a swift cycle depressurization step wherein the average rate of depressurization was about 80 psi/sec to about 1000 psi, and the remainder of the depressurization (e.g., to about atmospheric pressure) was done at less than about 2.5 psi/sec on average for the entire slow depressurization.

After complete depressurization the bag was oriented so that the product was in the bag away from the breathable strip, and the seal was made underneath the breathable strip of the bag. The bag was cooled by immersion in chilled water.

### Example 5

The following illustrative example of the processes described herein produced a potato product. Whole potatoes were sized to the desired raw material of 65 mm in length. The sized potatoes were washed and cut into size of 3/16 inch using a hand french fry cutter. The cut product was washed again in cold water to remove the excess starch.

The cut product was then blanched in hot water bath solution. The blanching solution consisted of GDL—gluconodeltalactone and citric acid at about 0.3% weight and 0.15% weight, respectively, of the total solution. The temperature of the blanching solution was about 180° F. The potatoes were blanched in the solution for about 15 minutes.

After blanching the potatoes were put into a batter solution which was maintained at a chilled temperature of about 42° F. The thin batter solution consisted about 58% moisture and 42% of the following ingredients: corn starch, rice flour, all-purpose flour, salt and glucose. The ratio of the ingredients was about 2:1:1:0.2:0.5 weight basis. The product was dipped into the batter solution for about 45 seconds. The weight of the batter solution was taken before the dipping exercise was performed and the weight after the dipping of the product was taken. The difference in the weight allowed for the calculation of the batter pick up by the product. It was calculated that at this viscosity the batter pick up was around 7-9% weight basis.

After the battering step the product was put through an oven cooking step wherein the temperature of cooking was at 350° F. The residence time for the product was about 3 minutes. The amount of moisture removal that occurred during the step was about 7-9%.

After the product was taken out from the oven it was directly placed within the hermetically sealed bags as shown in FIGS. 4A₁-4A₄. These bags are made using a film made from a combination of nylon and PET. In this format, this film is attached with the TYVEK® strip or a patch to make it into a bag where in the TYVEK® is placed on one side of the one end of the bag as shown in FIGS. 4A₁-4A₄. The processing aid solution was added to the bag. In this example, the processing aid solution consisted of distilled white Vinegar, Garlic Extract, Cumin Extract, DI water, GDL, Citric Acid in the ratio of 3:1:1:2:4:2 weight basis. The quantity of the solution added was about 15% of the total product before adding the solution. The bag was sealed and these sealed bag(s) were placed inside the high pressure chamber. The bags were placed within the chamber in an orientation such that breathable part is not blocked.

The high pressure chamber (5 liter) was sealed and the process of flowing the CO₂ into the chamber was started. The temperature of the CO₂ at the inlet is above 195° F. The CO₂ was first equilibrated to the CO₂ storage pressure of 750 psi after which the pressurization cycle was started. For this example a continuous cycle was operated. Therefore chamber was pressurized quickly to the supercritical state of a pressure of 2300 psi then for the remainder time, the carbon dioxide was added slowly at a flow rate of 20-25 gram/min introduced into the chamber with the same compressor by manually controlling the rate of compression. The chamber was initially pressurized to 2300 psi in one minute. The operating range for use with these processing aids is between 2300 psi to 3000 psi. By the end of the cycle the pressure achieved within the chamber was around 2700 psi. As shown in FIG. 10B, the rise of the temperature within the chamber was being recorded. Since the processing technique here was similar to technique described in example 2 therefore, the rise in temperature was same. After a temperature of 195° F. was maintained for 10 minutes, then the process of depressurization was done in two steps. The first step was a swift cycle depressurization step wherein the average rate of depressurization was about 100 psi/sec to about 700 psi, and the remainder of the depressurization (e.g., to about atmospheric pressure) was done at less than about 2.5 psi/sec on average for the entire slow depressurization.

The bag was oriented so that the product was in the bag away from the breathable strip and the seal was made underneath the breathable strip of the bag with a heat sealer. A temperature drop of 80-120° F. was achieved via immersion in chilled water, which results in minimizing the headspace as a result of partial vacuum formation within the bag due to the differential pressure between the inside and outside of the bag.

### Example 6

The following illustrative example of the processes described herein produced a potato product. Whole potatoes were sized to the desired raw material of 65 mm in length. The sized potatoes were washed and cut into size of 3/16 inch using a hand french fry cutter. The cut product was washed again in cold water to remove the excess starch.

The cut product was then blanched in hot water bath solution. The blanching solution consisted of GDL—gluconodeltalactone and citric acid at about 0.3% weight and 0.15% weight, respectively, of the total solution. The temperature of the blanching solution was about 180° F. The potatoes were blanched in the solution for about 15 minutes.

After blanching the potatoes were put into a batter solution which was maintained at a chilled temperature of about 42° F. The thin batter solution consisted about 58% moisture and 42% of the following ingredients: corn starch, rice flour, all-purpose flour, salt and glucose. The ratio of the ingredients was about 2:1:1:0.2:0.5 weight basis. The product was dipped into the batter solution for about 45 seconds. The weight of the batter solution was taken before the dipping exercise was performed and the weight after the dipping of the product was taken. The difference in the weight allowed for the calculation of the batter pick up by the product. It was calculated that at this viscosity the batter pick up was around 7-9% weight basis.

After the battering step the product was put through an oven cooking step wherein the temperature of cooking was at 350° F. The residence time for the product was about 3 minutes. The amount of moisture removal that occurred during the step was about 7-9%.

After the product was taken out from the oven it was directly placed within the hermetically sealed bags as shown in FIGS. 4B₂ and 4B₄. These bags are made using a film made from a combination of PE-EVA and PET. In this format, one side is made of breathable material, as shown in FIGS. 4B₂ and 4B₄ and FIGS. 13B and 13C. The processing aid solution was added to the bag. In this example, the processing aid solution consisted of distilled white Vinegar, Garlic Extract, Cumin Extract, DI water, GDL, Citric Acid in the ratio of 3:1:1:2:4:2 weight basis. The quantity of the solution added was about 15% weight of the total product before adding the solution. The bag was sealed and these sealed bag(s) were placed inside the high pressure chamber. The bags were placed within the chamber in an orientation such that breathable part is not blocked.

The high pressure chamber (5 liter) was sealed and the process of flowing the CO₂ into the chamber was started. The temperature of the CO₂ at the inlet is above 195° F. The CO₂ was first equilibrated to the CO₂ storage pressure of 750 psi after which the pressurization cycle was started. For this example a continuous cycle was operated. Therefore chamber was pressurized quickly to the supercritical state of a pressure of 2300 psi, then for the remainder time, the carbon dioxide was added slowly at a flow rate of 20-25 gram/min introduced into the chamber with the same compressor by manually controlling the rate of compression. The chamber was initially pressurized to 2300 psi in one minute. The operating range for use with these processing aids is between 2300 psi to 3000 psi. By the end of the cycle the pressure achieved within the chamber was around 2700 psi. As shown in FIG. 10B, the rise of the temperature within the chamber was being recorded. Since the processing technique here was similar to technique described in example 2 therefore, the rise in temperature was same. After a temperature of 195° F. was maintained for 10 minutes, then the process of depressurization was done in two steps. The first step was a swift cycle depressurization step wherein the average rate of depressurization was about 100 psi/sec to about 500 psi and the remainder of the depressurization (e.g., to about atmospheric pressure) was done at less than about 2.5 psi/sec on average for the entire slow depressurization.

The bags after removal from the supercritical system were placed in another bag made entirely of non-breathable material followed by making a seal on the non-breathable bag with the breathable bag enclosed inside (e.g., FIGS. 13A-13C). This bag was cooled by immersion in chilled water. A temperature drop of 80-120° F. was achieved via this step, which results in minimizing the headspace as a result of partial vacuum formation within the bag due to the differential pressure between the inside and outside of the bag.

### Example 7

The following illustrative example of the processes described herein produced a potato product. Whole potatoes were sized to the desired raw material of 65 mm in length. The sized potatoes were washed and cut into size of 3/16 inch using a hand french fry cutter. The cut product was washed again in cold water to remove the excess starch.

The cut product was then blanched in hot water bath solution. The blanching solution consisted of GDL—gluconodeltalactone and citric acid at about 0.3% weight and 0.15% weight, respectively, of the total solution. The temperature of the blanching solution was about 180° F. The potatoes were blanched in the solution for about 15 minutes.

After blanching the potatoes were put into a batter solution which was maintained at a chilled temperature of about 42° F. The thin batter solution consisted about 58% moisture and 42% of the following ingredients: corn starch, rice flour, all-purpose flour, salt and glucose. The ratio of the ingredients was about 2:1:1:0.2:0.5 weight basis. The product was dipped into the batter solution for about 45 seconds. The weight of the batter solution was taken before the dipping exercise was performed and the weight after the dipping of the product was taken. The difference in the weight allowed for the calculation of the batter pick up by the product. It was calculated that at this viscosity the batter pick up was around 7-9% weight basis.

After the battering step the product was put through an oven cooking step wherein the temperature of cooking was at 350° F. The residence time for the product was about 3 minutes. The amount of moisture removal that occurred during the step was about 7-9%.

After the product was taken out from the oven it was directly placed within the hermetically sealed bags as shown in FIGS. 4C₁-4C₄. These bags are made using a film made from a combination of LLDPE, Nylon and PET. In this format the bags have a gusseted area at the bottom, made of the breathable material, as shown in FIGS. 4C₁-4C₄. The processing aid solution was added to the bag. In this example, the processing aid solution consisted of distilled white Vinegar, Garlic Extract, Cumin Extract, DI water, GDL, Citric Acid in the ratio of 3:1:1:2:4:2 weight basis. The quantity of the solution added was about 15% of the total product before adding the solution. The bag was sealed and these sealed bag(s) were placed inside the high pressure chamber. The bags were placed within the chamber in an orientation, such that breathable part is not blocked.

The high pressure chamber (5 liter) was sealed and the process of flowing the CO₂ into the chamber was started. The temperature of the CO₂ at the inlet is above 195° F. The CO₂ was first equilibrated to the CO₂ storage pressure of 750 psi after which the pressurization cycle was started. For this example a continuous cycle was operated. Therefore chamber was pressurized quickly to the supercritical state of a pressure of 2300 psi, then for the remainder time, the carbon dioxide was added slowly at a flow rate of 20-25 gram/min introduced into the chamber with the same compressor by manually controlling the rate of compression. The chamber was initially pressurized to 2300 psi in one minute. The operating range for use with these processing aids is between 2300 psi to 3000 psi. By the end of the cycle the pressure achieved within the chamber was around 2700 psi. As shown in FIG. 10B, the rise of the temperature within the chamber was being recorded. Since the processing technique here was similar to technique described in example 2 therefore, the rise in temperature was same. After a temperature of 195° F. was maintained for 10 minutes, then the process of depressurization was done in two steps. The first step was a swift cycle depressurization step wherein the average rate of depressurization was about 100 psi/sec to about 500 psi, and the remainder of the depressurization (e.g., to about atmospheric pressure) was done at less than about 2.5 psi/sec on average for the entire slow depressurization.

The bags after removal from the supercritical system were sealed by joining the ends of the polymer material to enclose the breathable strip within (e.g., FIG. 4C₄). This final packaged bag were placed in chilled water. A temperature drop of 80-120° F. was achieved via this step, which results in minimizing the headspace as a result of partial vacuum formation within the bag due to the differential pressure between the inside and outside of the bag.

Similar to the ⅜ inch french fry as described in example 1, a puncture test was performed on four random samples of the inventive french fry product along with controls of frozen french fries according to the protocol above. These samples were analyzed 20 minutes after the frying using the puncture test described above and the average value of the 16 readings was plotted in FIG. 6B. The highest value within the range was recorded at 4000 grams and minimum value at 2123.333 grams peak positive force. FIG. 7 shows the results of the puncture testing, which reveals that the inventive french fry product had a 2 times higher peak force compared to the frozen french fry (about 475 grams for the example 1 product versus about 200 grams for the frozen product). This shows that the inventive french fry has a better hold time compared to the frozen counterpart.

### Example 8

The following illustrative example of the processes described herein produced a potato product. Whole potatoes were sized to the desired raw material of 65 mm in length. The sized potatoes were washed and cut into size of ⅜ inch using a hand french fry cutter. The cut product was washed again in cold water to remove the excess starch. The sample size of washed and cut potato ready for further processing was 300 gram. The variety of the potato being used for this example was Wonita which has a dry matter of about 17-19%.

The cut product was then blanched in hot water bath solution. The blanching solution consisted of GDL—gluconodeltalactone and citric acid at about 0.3% weight and 0.15% weight, respectively, of the total solution. The temperature of the blanching solution was about 180° F. The potatoes were blanched in the solution for about 15 minutes.

After blanching the potatoes were put into a batter solution which was maintained at a chilled temperature of about 42° F. The thin batter solution consisted about 58% moisture and 42% of the following ingredients: corn starch, rice flour, all-purpose flour, salt and glucose. The ratio of the ingredients was about 2:1:1:0.2:0.5 weight basis. The product was dipped into the batter solution for about 45 seconds. The weight of the batter solution was taken before the dipping exercise was performed and the weight after the dipping of the product was taken. The difference in the weight allowed for the calculation of the batter pick up by the product. It was calculated that at this viscosity the batter pick up was around 7-9% weight basis.

After the battering step the product was put through an oven cooking step wherein the temperature of cooking was at 350° F. The residence time for the product was about 3 minutes. The amount of moisture removal that occurred during the step was about 7-9%.

After the product was taken out from the oven it was directly placed within the hermetically sealed bags as shown in FIGS. 4C₁-4C₄. These bags are made using a film made from a combination of LLDPE, Nylon and PET. In this format the bags have a gusseted area at the bottom, made of the breathable material, as shown in FIGS. 4C₁-4C₄. The processing aid solution was added to the bag. In this example, the processing aid solution consisted of distilled white Vinegar, Garlic Extract, Cumin Extract, canola oil in the ratio of 2:0.5:0.5:2 weight basis. This formulation of the processing aid shall result in an end french fry product (par frying) with about 2% initial fat content. The quantity of the solution added was about 5% of the total product before adding the solution. The bag was sealed and these sealed bag(s) were placed inside the high pressure chamber. The bags were placed within the chamber in an orientation, such that breathable part is not blocked.

The high pressure chamber (5 liter) was sealed and the process of flowing the CO₂ into the chamber was started. The temperature of the CO₂ at the inlet is above 195° F. The CO₂ was first equilibrated to the CO₂ storage pressure of 750 psi after which the pressurization cycle was started. For this example a continuous cycle was operated. Therefore chamber was pressurized quickly to the supercritical state of a pressure of 2300 psi, then for the remainder time, the carbon dioxide was added slowly at a flow rate of 20-25 gram/min introduced into the chamber with the same compressor by manually controlling the rate of compression. The chamber was initially pressurized to 2300 psi in one minute. The operating range for use with these processing aids is between 2300 psi to 3000 psi. By the end of the cycle the pressure achieved within the chamber was around 2700 psi. As shown in FIG. 10B, the rise of the temperature within the chamber was being recorded. Since the processing technique here was similar to technique described in example 2 therefore, the rise in temperature was same. After a temperature of 195° F. was maintained for 10 minutes, then the process of depressurization was done in two steps. The first step was a swift cycle depressurization step wherein the average rate of depressurization was about 100 psi/sec to about 500 psi, and the remainder of the depressurization (e.g., to about atmospheric pressure) was done at less than about 2.5 psi/sec on average for the entire slow depressurization. The net weight of the product within the packaging was measured to be 300 gram. The net weight was calculated by subtracting the weight of the empty bag from the gross weight after processing. It is expected that when starting with potato varieties with solids lower than 17 wt %, certain product embodiments can achieve a final product moisture content of about 85 wt % within the final product.

The bags after removal from the supercritical system were sealed by joining the ends of the polymer material to enclose the breathable strip within (e.g., FIG. 4C₄). This final packaged bag was placed in chilled water. A temperature drop of 80-120° F. was achieved via this step, which results in minimizing the headspace as a result of partial vacuum formation within the bag due to the differential pressure between the inside and outside of the bag.

### Example 9

The following illustrative example of the processes described herein produced a potato product. Whole potatoes were sized to the desired raw material of 65 mm in length. The sized potatoes were washed and cut into size of ⅜ inch using a hand french fry cutter. The cut product was washed again in cold water to remove the excess starch. The sample size of washed and cut potato ready for further processing was 300 gram. The variety of the potato being used for this example was Wonita which has a dry matter of about 17-19%.

The cut product was then blanched in hot water bath solution. The blanching solution consisted of GDL—gluconodeltalactone and citric acid at about 0.3% weight and 0.15% weight, respectively, of the total solution. The temperature of the blanching solution was about 180° F. The potatoes were blanched in the solution for about 15 minutes.

After blanching the potatoes were put into a batter solution which was maintained at a chilled temperature of about 42° F. The thin batter solution consisted about 58% moisture and 42% of the following ingredients: corn starch, rice flour, all-purpose flour, salt and glucose. The ratio of the ingredients was about 2:1:1:0.2:0.5 weight basis. The product was dipped into the batter solution for about 45 seconds. The weight of the batter solution was taken before the dipping exercise was performed and the weight after the dipping of the product was taken. The difference in the weight allowed for the calculation of the batter pick up by the product. It was calculated that at this viscosity the batter pick up was around 8-10% weight basis.

After the battering step the product was put through an oven cooking step wherein the temperature of cooking was at 350° F. The residence time for the product was about 10 minutes. The amount of moisture removal that occurred during the step was about 20-30%.

After the product was taken out from the oven it was directly placed within the hermetically sealed bags as shown in FIGS. 4C₁-4C₄. These bags are made using a film made from a combination of LLDPE, Nylon and PET. In this format the bags have a gusseted area at the bottom, made of the breathable material, as shown in FIGS. 4C₁-4C₄. The processing aid solution was added to the bag. In this example, the processing aid solution consisted of distilled white Vinegar, Garlic Extract, Cumin Extract, DI water, GDL, Citric Acid in the ratio of 3:1:1:2:4:2 weight basis. The quantity of the solution added was about 7% of the total product before adding the solution. The bag was sealed and these sealed bag(s) were placed inside the high pressure chamber. The bags were placed within the chamber in an orientation, such that breathable part is not blocked.

The high pressure chamber (5 liter) was sealed and the process of flowing the CO₂ into the chamber was started. The temperature of the CO₂ at the inlet is above 195° F. The CO₂ was first equilibrated to the CO₂ storage pressure of 750 psi after which the pressurization cycle was started. For this example a continuous cycle was operated. Therefore chamber was pressurized quickly to the supercritical state of a pressure of 2300 psi, then for the remainder time, the carbon dioxide was added slowly at a flow rate of 20-25 gram/min introduced into the chamber with the same compressor by manually controlling the rate of compression. The chamber was initially pressurized to 2300 psi in one minute. The operating range for use with these processing aids is between 2300 psi to 3000 psi. By the end of the cycle the pressure achieved within the chamber was around 2700 psi. As shown in FIG. 10B, the rise of the temperature within the chamber was being recorded. Since the processing technique here was similar to technique described in example 2 therefore, the rise in temperature was same. After a temperature of 195° F. was maintained for 10 minutes, then the process of depressurization was done in two steps. The first step was a swift cycle depressurization step wherein the average rate of depressurization was about 100 psi/sec to about 500 psi, and the remainder of the depressurization (e.g., to about atmospheric pressure) was done at less than about 2.5 psi/sec on average for the entire slow depressurization. The net weight of the product within the packaging was measured to be 200 gram. The net weight was calculated by subtracting the weight of the empty bag from the gross weight after processing. It is expected that when starting with potato varieties with solids lower than 17 wt %, certain embodiments of the final product would achieve a final product with moisture content of about 85 wt % within the final product. Similarly, it is also expected that with thicker product cuts (e.g., ½ inch thickness and ½ inch width, “wedge” potato cuts), certain embodiments of the final product would achieve a moisture content of about 65 wt % after frying.

The bags after removal from the supercritical system were sealed by joining the ends of the polymer material to enclose the breathable strip within (e.g., FIG. 4C₄). This final packaged bag were placed in chilled water. A temperature drop of 80-120° F. was achieved via this step, which results in minimizing the headspace as a result of partial vacuum formation within the bag due to the differential pressure between the inside and outside of the bag.

Similar to example 1, a few random samples (5-6 pieces of potato french fry) were about 0.5-1.0% weight basis of the total sample within the bag. These samples were the standard ⅜ inch width and thickness french fry samples from the processed bag, which were fried in canola oil at a temperature of 350° F. for 3 minutes. Frozen french fry samples were also fried in canola oil at the same temperature and for the same amount of time. In other embodiments, the samples would be fried in canola oil for about 4 minutes. The product samples and the frozen french fry samples were analyzed for moisture and fat content analysis. The methodology referenced for the determining the fat content was AOAC 933.05 and the methodology referenced for the determining the moisture content was AOAC 984.25. The results of moisture and fat content testing are shown in FIG. 8B. The post-frying moisture content of the samples processed according to the embodiment of the current invention described above is higher than the frozen french fry and the fat content is significantly less compared to the frozen french fry samples. Thus, the post frying fat to moisture ratio of the samples produced according to an embodiment of the invention is lower than the frozen french fry control.

Similar to the ⅜ inch french fry as described in example 1, a puncture test was performed on four random samples of the inventive french fry product along with controls of frozen french fries according to the protocol above. These samples were analyzed 20 minutes after the frying using the puncture test described above and the average value of the 16 readings was plotted in FIG. 7. The highest value within the range was recorded at 2500.232 grams and minimum value at 1023.334 grams peak positive force. FIG. 6C shows the results of the puncture testing, which reveals that the inventive french fry product had significantly higher peak force compared to the frozen french fry (about 1334 grams for the example 9 product versus about 200 grams for the frozen product). This shows that the inventive french fry has a better hold time compared to the frozen counterpart.

### Example 10

The following illustrative example of the processes described herein produced a potato product. Whole potatoes were sized to the desired raw material of 65 mm in length. The sized potatoes were washed and cut into size of ⅜ inch using a hand french fry cutter. The cut product was washed again in cold water to remove the excess starch. The sample size of washed and cut potato ready for further processing was 300 gram. The variety of the potato being used for this example was Kennebec which has a dry matter of about 20%.

The cut product was then blanched in hot water bath solution. The blanching solution consisted of GDL—gluconodeltalactone and citric acid at about 0.3% weight and 0.15% weight, respectively, of the total solution. The temperature of the blanching solution was about 180° F. The potatoes were blanched in the solution for about 15 minutes.

After blanching the potatoes were put into a batter solution which was maintained at a chilled temperature of about 42° F. The thin batter solution consisted about 58% moisture and 42% of the following ingredients: corn starch, rice flour, all-purpose flour, salt and glucose. The ratio of the ingredients was about 2:1:1:0.2:0.5 weight basis. The product was dipped into the batter solution for about 45 seconds. The weight of the batter solution was taken before the dipping exercise was performed and the weight after the dipping of the product was taken. The difference in the weight allowed for the calculation of the batter pick up by the product. It was calculated that at this viscosity the batter pick up was around 7-9% weight basis.

After the battering step the product was put through an oven cooking step wherein the temperature of cooking was at 350° F. The residence time for the product was about 3 minutes. The amount of moisture removal that occurred during the step was about 7-9%.

After the product was taken out from the oven it was directly placed within the hermetically sealed bags as shown in FIGS. 4A₁-4A₄. These bags are made using a film made from a combination of nylon and PET. In this format, this film is attached with the TYVEK® strip or a patch to make it into a bag where in the TYVEK® is placed on one side of the one end of the bag as shown in FIGS. 4A₁-4A₄. The processing aid solution was added to the bag. In this example, the processing aid solution included distilled white vinegar of 5% acidity and DI Water in a ratio 3:4 weight basis. The quantity of the solution added was about 7% of the total product before adding the solution. The bag was sealed and these sealed bag/s were placed inside the high pressure chamber. The bags are placed within the chamber in an orientation, such that breathable part is not blocked.

The high pressure chamber (5 liter) was sealed and the process of flowing the CO₂ into the chamber was started. The temperature of the CO₂ at the inlet is above 195° F. The CO₂ was first equilibrated to the CO₂ storage pressure of 750 psi after which the further pressure within the chamber is built up by supplying CO₂ to a pump/compressor that pressurizes the carbon dioxide within the chamber. For this example a no feed process was used. Therefore the chamber was pressurized to a value of 1075 psi in 2 minutes and then the feed flow was stopped. In other embodiments, the operating range for use with these processing aids is between 1070 psi to 3000 psi. As shown in FIG. 10C, the rise of the temperature within the chamber was being recorded. After an internal temperature of 195° F. was maintained for 10 minutes, the system was depressurized. The process of depressurization was done in two steps. The first step was a swift cycle depressurization step to allow for phase change of the carbon dioxide from supercritical to gas phase wherein the depressurization was conducted within 1 second and the remainder of the depressurization (e.g., to about atmospheric pressure) was done in more than 1 minute. In other embodiments, the total swift cycle depressurization time would be within 3 seconds. In other embodiments, the total swift cycle depressurization time would be within 5 seconds. In other embodiments, the total swift cycle depressurization time would be within 7 seconds. In other embodiments, the total swift cycle depressurization time would be within 10 seconds. In other embodiments, the total swift cycle depressurization time would be within 15 seconds. In other embodiments, the total swift cycle depressurization time would be within 20 seconds.

The net weight of the product within the packaging was measured to be 300 gram. The net weight was calculated by subtracting the weight of the empty bag from the gross weight after processing. And final pH of the product was recorded at 4.33. It is expected that when starting with potato varieties with solids lower than 17 wt %, certain embodiments of the final product would achieve a final product with moisture content of about 85 wt % within the final product.

The bag was oriented so that the product was in the bag away from the breathable strip and the seal was made underneath the breathable strip of the bag using a heat sealer similar to that shown in FIG. 2. A temperature drop of 80-120° F. was achieved via immersion in chilled water, which results in minimizing the headspace as a result of partial vacuum formation within the bag due to the differential pressure between the inside and outside of the bag.

### Example 11

The following illustrative example of the processes described herein produced a potato product. Whole potatoes were sized to the desired raw material of 65 mm in length. The sized potatoes were washed and cut into size of ⅜ inch using a hand french fry cutter. The cut product was washed again in cold water to remove the excess starch. The sample size of washed and cut potato ready for further processing was 30 grams. The variety of the potato being used for this example was Lamoka which has a dry matter of about 21-22%.

The cut product was then blanched in hot water bath solution. The blanching solution consisted of GDL—gluconodeltalactone and citric acid at about 0.3% weight and 0.15% weight, respectively, of the total solution. The temperature of the blanching solution was about 180° F. The potatoes were blanched in the solution for about 15 minutes.

After blanching the potatoes were put into a batter solution which was maintained at a chilled temperature of about 42° F. The thin batter solution consisted about 58% moisture and 42% of the following ingredients: corn starch, rice flour, all-purpose flour, salt and glucose. The ratio of the ingredients was about 2:1:1:0.2:0.5 weight basis. The product was dipped into the batter solution for about 45 seconds. The weight of the batter solution was taken before the dipping exercise was performed and the weight after the dipping of the product was taken. The difference in the weight allowed for the calculation of the batter pick up by the product. It was calculated that at this viscosity the batter pick up was around 7-9% weight basis.

After the battering step the product was put through an oven cooking step wherein the temperature of cooking was at 350° F. The residence time for the product was about 3 minutes. The amount of moisture removal that occurred during the step was about 7-9%.

After the product was taken out from the oven it was directly placed within the hermetically sealed bags as shown in FIGS. 4A₁-4A₄. These bags are made using a film made from a combination of nylon and PET. In this format, this film is attached with the TYVEK® strip or a patch to make it into a bag where in the TYVEK® is placed on one side of the one end of the bag as shown in FIGS. 4A₁-4A₄. The processing aid solution was added to the bag. In this example, the processing aid solution consisted of distilled white Vinegar, Garlic Extract, Cumin Extract, DI water, GDL, Citric Acid in the ratio of 3:1:1:2:4:2 weight basis. The quantity of the solution added was about 7% of the total product before adding the solution. The bag was sealed and these sealed bag/s were placed inside the high pressure chamber. The bags are placed within the chamber in an orientation, such that breathable part is not blocked.

The high pressure chamber (500 milliliter) was sealed and the process of flowing the CO₂ into the chamber was started. The temperature of the CO₂ at the inlet is above 195° F. The CO₂ was first equilibrated to the CO₂ storage pressure of 750 psi after which the further pressure within the chamber is built up by supplying CO₂ to a pump/compressor that pressurizes the carbon dioxide within the chamber. For this example a no feed process was used. Therefore the chamber was pressurized to a value of 7000 psi in 5 minutes and then the feed flow was stopped. In other embodiments, the operating range for use with these processing aids is between 1070 psi to 7000 psi. As shown in FIG. 10C, the rise of the temperature within the chamber was being recorded. After an internal temperature of 195° F. was maintained for 10 minutes, the system was depressurized. The process of depressurization was done in two steps. The first step was a swift cycle depressurization step to allow for phase change of the carbon dioxide from supercritical to gas phase wherein the depressurization was conducted within 30 seconds and the remainder of the depressurization (e.g., to about atmospheric pressure) was done in more than 1 minute. In other embodiments, the total swift cycle depressurization time would be within 40 seconds. In other embodiments, the total swift cycle depressurization time would be within 50 seconds. In other embodiments, the total swift cycle depressurization time would be within 60 seconds.

The net weight of the product within the packaging was measured to be 30 gram. The net weight was calculated by subtracting the weight of the empty bag from the gross weight after processing. And final pH of the product was recorded at 4.33.

The bag was oriented so that the product was in the bag away from the breathable strip and the seal was made underneath the breathable strip of the bag using a heat sealer similar to that shown in FIG. 2. A temperature drop of 80-120° F. was achieved via immersion in chilled water, which results in minimizing the headspace as a result of partial vacuum formation within the bag due to the differential pressure between the inside and outside of the bag.

As set forth above, embodiments of the supercritical carbon dioxide process impart an equilibrium pH below 4.6 that is roughly uniform throughout the treated product. For clarity, while the pH may vary slightly throughout the product, it is understood that localized departures of pH from the average pH of the product will still be below 4.6. Further pH test data of products created by embodiments of the supercritical carbon dioxide process are presented in Table 1. The products of Table 1 were produced by the blanching step and supercritical carbon dioxide process step of Example 1 using only distilled white vinegar of 5% acidity as the processing aid solution and with a residence time at peak pressure of 1 minute. The quantity of processing aid solution added, as a percentage of the total product before adding the solution, is provided in Table 1. In Table 1, the thickness and width of the cross-sectional center portion of the cut potato product was half that of the thickness and width of the cut potato product. Thus, the thickness and width of the cross-sectional center for the ½ inch sample was ¼ inch; for the ⅜ inch sample, it was 3/16 inch; for the 3/16 inch sample, it was 3/32 inch. Table 1 shows that the pH of the potato product produced by these processes vary less than about 0.15 throughout the product.

TABLE 1
pH measurements of potato products

| Cut Potato | Amount of | | |
|---|---|---|---|
| Thickness and | Processing Aid | | pH of Cross |
| Width (inches) | (wt %) | pH of Cut Potato | Sectional Center |
| 3/16 | 5% | 4.22-4.25 | 4.23-4.26 |
| ⅜ | 5% | 4.31-4.32 | 4.32-4.34 |
| ½ | 8% | 4.17-4.19 | 4.32-4.34 |

Illustrative embodiments of the processes, methods, and products of the present disclosure are described herein. It should be understood, however, that the description herein of the specific embodiments is not intended to limit the present disclosure to the particular forms disclosed but, on the contrary, the intention is to cover all modifications, equivalents, and alternatives falling within the spirit and scope of the invention by the appended claims. Thus, although the present invention has been described for the purpose of illustration, it is understood that such detail is solely for that purpose and variations can be made by those skilled in the art without departing from the spirit and scope of the invention which is defined by the following claims.

1. A product comprising:
a flexible packaging, and
a cut potato product disposed within the flexible packaging, the potato product comprising:
a pH below about 4.6 throughout the cut potato product, wherein the pH varies less than about 0.15 throughout the cut potato product;
a moisture content of about 65 wt % to about 85 wt %; and
a fat content of about 0 wt % to about 2 wt %.

2. The product of claim 1, the cut potato product having a width dimension of about 3/16 inch to about ½ inch and a thickness dimension of about 3/16 inch to about ½ inch.

3. The product of claim 1, wherein the cut potato product has a moisture content of about 70 wt % to about 85 wt %.

4. The product of claim 1, wherein the cut potato product has a solids content of about 15 wt % to about 30 wt %.

5. The product of claim 1, wherein the cut potato product has a pH below 4.5 throughout the cut potato product.

6. The product of claim 1, wherein the flexible packaging lacks an acidic solution suspension.

7. The product of claim 1, the cut potato product forming a cooked potato product after being fried in canola oil for about 3-4 minutes at about 350° F., the cooked potato product having a moisture content of about 45 wt % to about 55 wt %, and a fat content of about 6 wt % to about 12 wt %.

8. The product of claim 1, the cut potato product forming a cooked potato product after being fried in canola oil for about 3-4 minutes at about 350° F., the cooked potato product having a surface hardness measure of about 350 grams to about 2500 grams when measured by a puncture test using a 3mm probe at a test speed of 2mm/sec within 120 seconds of completing frying.

9. The product of claim 1, the cut potato product forming a cooked potato product after being fried in canola oil for about 3-4 minutes at about 350° F., the cooked potato product having a moisture content of about 53 wt % to about 65 wt %.

10. The product of claim 1, the cut potato product forming a cooked potato product after being fried in canola oil for about 3-4 minutes at about 350° F., the cooked potato product having a solids content of about 28 wt % to about 40 wt %.

11. The product of claim 1, the cut potato product forming a cooked potato product after being fried in canola oil for about 3-4 minutes at about 350° F., the cooked potato product having a fat content of about 6 wt % to about 10 wt %.

12. The product of claim 1, the cut potato product having a width of about ⅜ inch and a thickness of about 3/8 inch, the cut potato product forming a cooked potato product after being fried in canola oil for about 3-4 minutes at about 350° F., the cooked potato product having a surface hardness measure of about 300 grams to about 500 grams when measured by a puncture test using a 3mm probe at a test speed of 2mm/sec within about 120 seconds of completing frying.

13. The product of claim 1, the cut potato product having a width of about 3/16 inch and a thickness of about 3/16 inch, the cut potato product forming a cooked potato product after being fried in canola oil for about 90 seconds at about 350° F., the cooked potato product having a surface hardness measure of about 2000 grams to about 4000 grams when measured by a puncture test using a 3mm probe at a test speed of 2mm/sec within about 120 seconds of completing frying.

14. The product of claim 1, wherein an interior volume of the flexible packaging is at a partial vacuum pressure.

15. The product of claim 1, wherein the flexible packaging comprises a first section having a first permeability that is greater than a permeability of a remainder of the flexible packaging, and wherein an internal volume of the remainder of the flexible packaging accommodates receipt of the entirety of the cut potato product.

16. The product of claim 15, wherein the interior volume of the remainder of the flexible packaging is at a partial vacuum pressure.

17. The product of claim 1, further comprising a second flexible packaging, wherein the flexible packaging is sealed within the second flexible packaging, and wherein at least part of the flexible packaging has a permeability that is greater than a permeability of the second flexible packaging.

18. The product of claim 17, wherein an interior volume of the second flexible packaging is at a partial vacuum pressure.

19. The product of claim 1, wherein the flexible packaging is disposable in first and second configurations, the first configuration comprising a first section of the flexible packaging being on an exterior of the flexible packaging, the first section having a first permeability that is greater than a permeability of the remainder of the flexible packaging, and the second configuration comprising the first section being enclosed within an interior of the flexible packaging.

20. The product of claim 19, wherein the first section comprises a gusset of the flexible packaging.

21. The product of claim 19, wherein an interior volume of the flexible packaging is at a partial vacuum pressure.

22. The product of claim 1, wherein the flexible packaging comprises first and second internal spaces, with a first partition between the first and second internal spaces, the first partition having a first permeability that is greater than a permeability of the remainder of the flexible packaging, and wherein the cut potato product is in the first internal space.

23. The product of claim 22, wherein the first internal space of the flexible packaging is at a partial vacuum pressure.

24. The product of claim 1, the cut potato product further comprising a batter.

25. The product of claim 24, wherein the batter comprises one or more of a native starch, a modified starch, salt, sugar, glucose, dextrose, a flavoring agent, or a spice.

26. The product of claim 1, wherein the cut potato product is substantially free from artificial preservatives.

27-67. (canceled)
